(19) United States
(12) Patent Application Publication
(10) Pub. No.: US 2024/0107571 A1
(43) Pub. Date: Mar. 28, 2024

(54) REPEATERS WITH CIRCULAR POLARIZATION

(71) Applicant: Qualcomm Incorporated, San Diego, CA (US)

(72) Inventors: Navid Abedini, Basking Ridge, NJ (US); Juergen Cezanne, Ocean Township, NJ (US); Junyi Li, Fairless Hills, PA (US)

(21) Appl. No.: 17/955,373

(22) Filed: Sep. 28, 2022

(51) Int. Cl. H04W 72/08; H01Q 15/24; H04W 8/22; H04W 72/04

(52) U.S. Cl. CPC H04W 72/087; H01Q 15/244; H04W 8/22; H04W 72/048

(57) ABSTRACT

Methods, systems, and devices for wireless communications are described. Wireless communications systems may support communications between various network nodes via repeaters to extend coverage to areas that may be otherwise uncovered. A repeater may forward a signal using a circular polarization type. A receiving network node may receive a signal transmitted with a circular polarization type using a linear antenna configuration without a risk of the signal being orthogonal to the linear antenna configuration, and therefore not received by the receiving network node. A repeater may report, to a control entity, a capability of the repeater to forward signals using a set of one or more polarization types (e.g., including at least one circular polarization type), and in response the repeater may receive scheduling information indicating for the repeater to forward a signal in a given communication resource using a particular polarization type (e.g., a particular circular polarization type).

### INTRODUCTION

The following relates to wireless communications relating to repeaters and circular polarization.

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support repeaters with circular polarization. For example, the described techniques provide for forwarding signals via a repeater using a circular polarization type. Wireless communications systems may support communications between various network nodes (e.g., user equipments (UE)s or network entities) via repeaters to extend coverage to areas that may be otherwise uncovered. A repeater may forward a signal using a circular polarization type (e.g., a clockwise circular polarization type or a counterclockwise circular polarization type). A receiving network node may receive a signal transmitted with a circular polarization type using a linear antenna configuration without a risk of the signal being orthogonal to the linear antenna configuration, and therefore not received by the receiving network node. In some aspects, a repeater may report, to a control entity such as a network entity or a UE, a capability of the repeater to forward signals using a set of one or more polarization types (e.g., including at least one circular polarization type), and in response the repeater may receive scheduling information indicating for the repeater to forward a signal in a given communication resource using a particular polarization type (e.g., a particular circular polarization type). The repeater may forward a signal received via the given communication resource using the indicated particular polarization type.

A method for wireless communications at a first network node is described. The method may include transmitting control information including an indication of a capability of the first network node to support forwarding in accordance with a first set of one or more polarization types, receiving, based on the control information, scheduling information for a communication resource, where the scheduling information includes an indication to apply a particular polarization type of the first set of one or more polarization types to the communication resource, and forwarding a signal received from a second network node via the communication resource to a third network node in accordance with the scheduling information.

A first network node for wireless communication is described. The first network node may include a memory and at least one processor coupled to the memory. The at least one processor is configured to transmit control information including an indication of a capability of the first network node to support forwarding in accordance with a first set of one or more polarization types, receive, based on the control information, scheduling information for a communication resource, where the scheduling information includes an indication to apply a particular polarization type of the first set of one or more polarization types to the communication resource, and forward a signal received from a second network node via the communication resource to a third network node in accordance with the scheduling information.

Another apparatus for wireless communications at a first network node is described. The apparatus may include means for transmitting control information including an indication of a capability of the first network node to support forwarding in accordance with a first set of one or more polarization types, means for receiving, based on the control information, scheduling information for a communication resource, where the scheduling information includes an indication to apply a particular polarization type of the first set of one or more polarization types to the communication resource, and means for forwarding a signal received from a second network node via the communication resource to a third network node in accordance with the scheduling information.

A non-transitory computer-readable medium having code for wireless stored thereon is described. The code when executed by a first network node, causes the network node to transmit control information including an indication of a capability of the first network node to support forwarding in accordance with a first set of one or more polarization types, receive, based on the control information, scheduling information for a communication resource, where the scheduling information includes an indication to apply a particular polarization type of the first set of one or more polarization types to the communication resource, and forward a signal received from a second network node via the communication resource to a third network node in accordance with the scheduling information.

In some examples of the method, apparatuses, and non-transitory computer-readable medium described herein, the one or more polarization types include at least one of a clockwise circular polarization and a counterclockwise circular polarization.

In some examples of the method, apparatuses, and non-transitory computer-readable medium described herein, the control information further includes an indication of a respective power configuration associated with each respective polarization type of the one or more polarization types.

Some examples of the method, apparatuses, and non-transitory computer-readable medium described herein may further include operations, features, means, or instructions for receive the signal in accordance with a particular polarization type of a second set of one or more polarization types, where the control information further includes an indication of a second capability of the first network node to support reception in accordance with the second set of one or more polarization types.

In some examples of the method, apparatuses, and non-transitory computer-readable medium described herein, the particular polarization type of the second set of one or more polarization types may be different than the particular polarization type of the first set of one or more polarization types.

In some examples of the method, apparatuses, and non-transitory computer-readable medium described herein, the particular polarization type of the second set of one or more polarization types may be the same as the particular polarization type of the first set of one or more polarization types.

Some examples of the method, apparatuses, and non-transitory computer-readable medium described herein may further include operations, features, means, or instructions for receiving the signal in accordance with a first circular polarization type, and where the particular polarization type of the first set of one or more polarization types includes a second circular polarization type different from the first circular polarization type.

In some examples of the method, apparatuses, and non-transitory computer-readable medium described herein, the control information further includes an indication of a second capability of the first network node to support simultaneous reception and forwarding of signals in accordance with different polarization types.

In some examples of the method, apparatuses, and non-transitory computer-readable medium described herein, the control information further includes an indication of a second capability of the first network node to support transmission in accordance with a second set of one or more polarization types.

In some examples of the method, apparatuses, and non-transitory computer-readable medium described herein, the control information further includes an indication of a second capability of the first network node to switch between forwarding in accordance with a first polarization type of the first set of one or more polarization types and forwarding in accordance with a second polarization type.

In some examples of the method, apparatuses, and non-transitory computer-readable medium described herein, the first polarization type includes a circular polarization type and the second polarization type includes a linear polarization type.

In some examples of the method, apparatuses, and non-transitory computer-readable medium described herein, the first polarization type includes a linear polarization type and the second polarization type includes a circular polarization type.

Some examples of the method, apparatuses, and non-transitory computer-readable medium described herein may further include operations, features, means, or instructions for receiving, based on the control information, second scheduling information for a second communication resource subsequent to the communication resource, where the second scheduling information includes an indication to apply the second polarization type to the second communication resource.

In some examples of the method, apparatuses, and non-transitory computer-readable medium described herein, the control information further includes an indication of a latency associated with a switch between forwarding in accordance with the first polarization type and forwarding in accordance with the second polarization type and the scheduling information may be based on the latency.

In some examples of the method, apparatuses, and non-transitory computer-readable medium described herein, the control information further includes an indication of a set of one or more power configurations associated with the first set of one or more polarization types and the scheduling information further includes an indication of a particular power configuration of the set of one or more power configurations to apply to the communication resource.

Some examples of the method, apparatuses, and non-transitory computer-readable medium described herein may further include operations, features, means, or instructions for receiving a second signal from the second network node and generating measurement information for a clockwise circular polarization type and a counterclockwise circular polarization type based on the second signal, where the control information further includes an indication of one of the clockwise circular polarization type or the counterclockwise circular polarization type, and where receiving the signal includes receiving the signal in accordance with the one of the clockwise circular polarization type or the counterclockwise circular polarization type.

Some examples of the method, apparatuses, and non-transitory computer-readable medium described herein may further include operations, features, means, or instructions for determining a first circular polarization type of the signal received from the second network node, where the particular polarization type includes a second circular polarization type determined based on the first circular polarization type.

A method for wireless communications at a first network node is described. The method may include receiving, from a second network node, control information including an indication of a capability of the second network node to support forwarding in accordance with a first set of one or more polarization types and transmitting, to the second network node and based on the control information, scheduling information for a communication resource, where the scheduling information includes an indication to apply a particular polarization type of the first set of one or more polarization types to the communication resource.

A first network node for wireless communication is described. The first network node may include a memory and at least one processor coupled to the memory. The at least one processor is configured to receive, from a second network node, control information including an indication of a capability of the second network node to support forwarding in accordance with a first set of one or more polarization types and transmit, to the second network node and based on the control information, scheduling information for a communication resource, where the scheduling information includes an indication to apply a particular polarization type of the first set of one or more polarization types to the communication resource.

Another apparatus for wireless communications at a first network node is described. The apparatus may include means for receiving, from a second network node, control information including an indication of a capability of the second network node to support forwarding in accordance with a first set of one or more polarization types and means for transmitting, to the second network node and based on the control information, scheduling information for a communication resource, where the scheduling information includes an indication to apply a particular polarization type of the first set of one or more polarization types to the communication resource.

A non-transitory computer-readable medium having code for wireless stored thereon is described. The code when executed by a first network node, causes the network node to receive, from a second network node, control information including an indication of a capability of the second network node to support forwarding in accordance with a first set of one or more polarization types and transmit, to the second network node and based on the control information, scheduling information for a communication resource, where the scheduling information includes an indication to apply a particular polarization type of the first set of one or more polarization types to the communication resource.

Some examples of the method, apparatuses, and non-transitory computer-readable medium described herein may further include operations, features, means, or instructions for transmitting a signal to the second network node via the communication resource for forwarding to a third network node.

Some examples of the method, apparatuses, and non-transitory computer-readable medium described herein may further include operations, features, means, or instructions for transmitting the signal in accordance with a first circular polarization type, where the particular polarization type includes a second circular polarization type different from the first circular polarization type.

In some examples of the method, apparatuses, and non-transitory computer-readable medium described herein, the control information further includes an indication of a second capability of the second network node to support simultaneous reception and forwarding of signals in accordance with different polarization types.

Some examples of the method, apparatuses, and non-transitory computer-readable medium described herein may further include operations, features, means, or instructions for transmitting a second signal to the second network node, where the control information further includes an indication of a selected one of a clockwise circular polarization type or a counterclockwise circular polarization type, and where transmitting the signal includes transmitting the signal in accordance with the selected one of the clockwise circular polarization type or the counterclockwise circular polarization type.

Some examples of the method, apparatuses, and non-transitory computer-readable medium described herein may further include operations, features, means, or instructions for receiving a signal from the second network node via the communication resource in accordance with the particular polarization type.

In some examples of the method, apparatuses, and non-transitory computer-readable medium described herein, the one or more polarization types include at least one of a clockwise circular polarization and a counterclockwise circular polarization.

In some examples of the method, apparatuses, and non-transitory computer-readable medium described herein, the control information further includes an indication of a respective power configuration associated with each respective polarization type of the one or more polarization types.

In some examples of the method, apparatuses, and non-transitory computer-readable medium described herein, the control information further includes an indication of a second capability of the second network node to support reception in accordance with a second set of one or more polarization types.

In some examples of the method, apparatuses, and non-transitory computer-readable medium described herein, the control information further includes an indication of a second capability of the second network node to support transmission in accordance with a second set of one or more polarization types.

In some examples of the method, apparatuses, and non-transitory computer-readable medium described herein, the control information further includes an indication of a second capability of the second network node to switch between forwarding in accordance with a first polarization type of the first set of one or more polarization types and forwarding in accordance with a second polarization type.

In some examples of the method, apparatuses, and non-transitory computer-readable medium described herein, the first polarization type includes a circular polarization type and the second polarization type includes a linear polarization type.

In some examples of the method, apparatuses, and non-transitory computer-readable medium described herein, the first polarization type includes a linear polarization type and the second polarization type includes a circular polarization type.

Some examples of the method, apparatuses, and non-transitory computer-readable medium described herein may further include operations, features, means, or instructions for transmitting, based on the control information, second scheduling information for a second communication resource subsequent to the communication resource, where the second scheduling information includes an indication to apply the second polarization type to the second communication resource.

In some examples of the method, apparatuses, and non-transitory computer-readable medium described herein, the control information further includes an indication of a latency associated with a switch between forwarding in accordance with the first polarization type and forwarding in accordance with the second polarization type and the scheduling information may be based on the latency.

In some examples of the method, apparatuses, and non-transitory computer-readable medium described herein, the control information further includes an indication of a set of one or more power configurations associated with the first set of one or more polarization types, the scheduling information further includes an indication of a particular power configuration of the set of one or more power configurations to apply to the communication resource, the control information further includes an indication of a set of one or more power configurations associated with the first set of one or more polarization types, and the scheduling information further includes an indication of a particular power configuration of the set of one or more power configurations to apply to the communication resource.

### BRIEF DESCRIPTION OF THE DRAWINGS

FIG. 1 illustrates an example of a wireless communications system that supports repeaters with circular polarization in accordance with one or more aspects of the present disclosure.

FIG. 2 illustrates an example of repeater configurations that support repeaters with circular polarization in accordance with one or more aspects of the present disclosure.

FIG. 3 illustrates an example of repeater configurations that support repeaters with circular polarization in accordance with one or more aspects of the present disclosure.

FIG. 4 illustrates an example of a wireless communications system that supports repeaters with circular polarization in accordance with one or more aspects of the present disclosure.

FIG. 5 illustrates an example of a process flow that supports repeaters with circular polarization in accordance with one or more aspects of the present disclosure.

FIGS. 6 and 7 show block diagrams of devices that support repeaters with circular polarization in accordance with one or more aspects of the present disclosure.

FIG. 8 shows a block diagram of a communications manager that supports repeaters with circular polarization in accordance with one or more aspects of the present disclosure.

FIG. 9 shows a diagram of a system including a device that supports repeaters with circular polarization in accordance with one or more aspects of the present disclosure.

FIGS. 10 and 11 show block diagrams of devices that support repeaters with circular polarization in accordance with one or more aspects of the present disclosure.

FIG. 12 shows a block diagram of a communications manager that supports repeaters with circular polarization in accordance with one or more aspects of the present disclosure.

FIG. 13 shows a diagram of a system including a UE that supports repeaters with circular polarization in accordance with one or more aspects of the present disclosure.

FIG. 14 shows a diagram of a system including a network entity that supports repeaters with circular polarization in accordance with one or more aspects of the present disclosure.

FIGS. 15 through 19 show flowcharts illustrating methods that support repeaters with circular polarization in accordance with one or more aspects of the present disclosure.

### DETAILED DESCRIPTION

A wireless communications system may support communications between various network nodes (e.g., user equipments (UE)s or network entities) via repeaters to extend coverage to areas that may be otherwise uncovered (e.g., due to fading due to distance or due to blockages) or to increase received signal strength and reliability. For example, a repeater may be served by the network and used to forward (e.g., repeat or relay) uplink signals and/or downlink signals between UEs and the network (e.g., via the Uu interface). In some examples, the repeater may serve one or multiple UEs, such that the repeater may forward sidelink signals between two UEs. In some aspects, a transmitting network node may transmit a signal to a repeater using linear polarization (e.g., using a horizontal (H) channel and a vertical (V) channel). The repeater may forward the signal using linear polarization. In some cases, one channel (e.g., the V channel) of the link between the transmitting network node and the repeater may be deeply faded. In such cases, the repeater may duplicate the signal received via the other channel (e.g., the H channel) to forward on both the H and V channels for the link between the repeater and the receiving network node. If the antenna of the receiving network node happens to be positioned at a −45 degree angle with respect to the V channel, then in such cases, the receiving network node will not receive any signal, as the received electric field would be orthogonal to the antenna. Additionally, or alternatively, some repeaters may receive signals using one polarization (e.g., H) and forward the signals using another polarization. However, if only one linear polarization is transmitted, in some examples, the receiving network node may not receive any signal if the received electric field is orthogonal to the antenna.

Accordingly, in some aspects, a repeater may forward a signal using a circular polarization type (e.g., a clockwise circular polarization type or a counterclockwise circular polarization type). A receiving network node may receive a signal transmitted with a circular polarization type using a linear antenna configuration without a risk of the signal being orthogonal to the linear antenna configuration, and therefore not received by the receiving network node. In some aspects, a repeater may report (e.g., to a control entity such as a network entity in Uu or sidelink mode 1, or a UE in sidelink mode 2) a capability of the repeater to forward signals using a set of one or more polarization types (e.g., including at least one circular polarization type), and in response the repeater may receive scheduling information indicating for the repeater to forward a signal in a given communication resource using a particular polarization type (e.g., a particular circular polarization type). The repeater may forward signals received in via a linear polarization type or a circular polarization type. The repeater may forward signals using a clockwise circular polarization type or a counterclockwise circular polarization type.

Aspects of the disclosure are initially described in the context of wireless communications systems. Aspects of the disclosure are further illustrated by and described with reference to repeater configurations and process flows. Aspects of the disclosure are further illustrated by and described with reference to apparatus diagrams, system diagrams, and flowcharts that relate to repeaters with circular polarization.

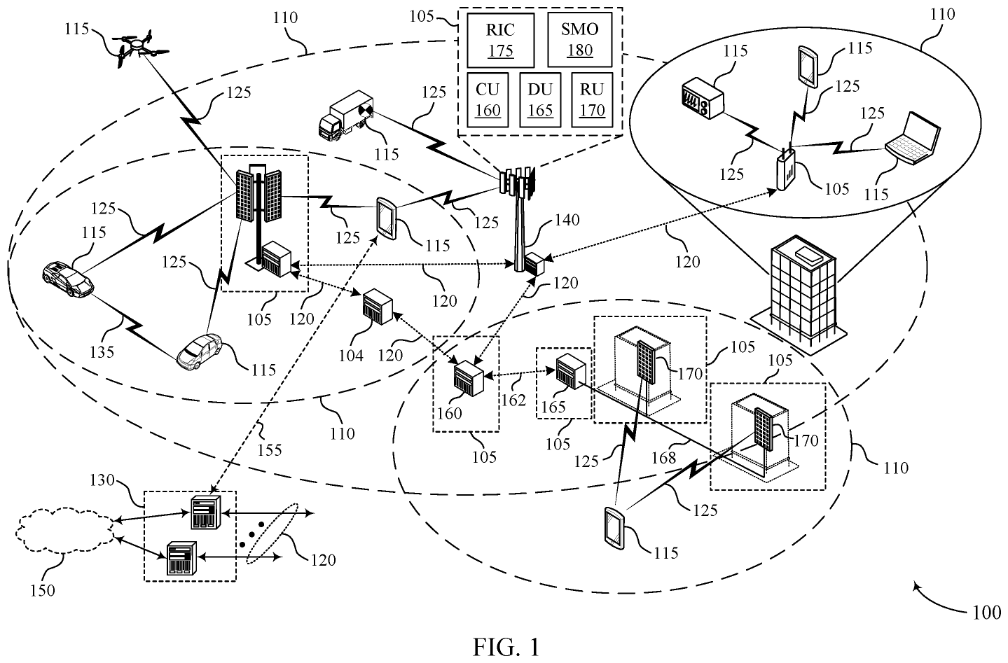

FIG. 1 illustrates an example of a wireless communications system 100 that supports repeaters with circular polarization in accordance with one or more aspects of the present disclosure. The wireless communications system 100 may include one or more network entities 105, one or more UEs 115, and a core network 130. In some aspects, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some aspects, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a node may be a repeater. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some aspects, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some aspects, network entities 105 may communicate with one another via a backhaul communication link 120 (e.g., in accordance with an X2, Xn, or other interface protocol) either directly (e.g., directly between network entities 105) or indirectly (e.g., via a core network 130). In some aspects, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some aspects, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some aspects, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some aspects, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some aspects, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some aspects, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some aspects, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support repeaters with circular polarization as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some aspects, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some aspects, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some aspects, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some aspects, the wireless communications system 100 may include network entities 105 or UEs 115 that support concurrent communications using carriers associated with multiple carrier bandwidths. In some aspects, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some aspects, a UE 115 may be configured with multiple BWPs. In some aspects, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and Af f may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some aspects, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some aspects, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID), or others). In some aspects, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications via the one or more cells using one or multiple component carriers.

In some aspects, a carrier may support multiple cells, and different cells may be configured according to different protocol types (e.g., MTC, narrowband IoT (NB-IoT), enhanced mobile broadband (eMBB)) that may provide access for different types of devices.

In some aspects, a network entity 105 (e.g., a base station 140, an RU 170) may be movable and therefore provide communication coverage for a moving coverage area 110. In some aspects, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some aspects, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some aspects, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some aspects, half-duplex communications may be performed at a reduced peak rate. Other power conservation techniques for the UEs 115 include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some aspects, a UE 115 may be configured to support communicating directly with other UEs 115 via a device-to-device (D2D) communication link 135 (e.g., in accordance with a peer-to-peer (P2P), D2D, or sidelink protocol). In some aspects, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some aspects, one or more UEs 115 of such a group may be outside the coverage area 110 of a network entity 105 or may be otherwise unable to or not configured to receive transmissions from a network entity 105. In some aspects, groups of the UEs 115 communicating via D2D communications may support a one-to-many (1:M) system in which each UE 115 transmits to each of the other UEs 115 in the group. In some aspects, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some aspects, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some aspects, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MIME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some aspects, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some aspects, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some aspects, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some aspects, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some aspects, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some aspects, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some aspects, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some aspects, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support communications between various network nodes (e.g., UEs 115 or network entities 105) via repeaters to extend coverage to areas that may be otherwise uncovered (e.g., due to fading due to distance or due to blockages) or to increase received signal strength and reliability. For example, a repeater may be served by the network and used to forward (e.g., repeat or relay) uplink signals and/or downlink signals between UEs 115 and a network entity (e.g., via the Uu interface). In some examples, the repeater may serve one or multiple UEs 115, such that the repeater may forward sidelink signals between two UEs 115. In another example, a repeater may serve multiple network entities 105, such that the repeater may forward backhaul signals between the network entities 105.

In some aspects, a transmitting network node may transmit a signal to a repeater using linear polarization (e.g., using an H channel and a V channel). The repeater may forward the signal using linear polarization. In some cases, one channel (e.g., the V channel) of the link between the transmitting network node and the repeater may be deeply faded. In such cases, the repeater may duplicate the signal received via other channel (e.g., the H channel) to forward on both the H and V channels for the link between the repeater and the receiving network node. If the antenna of the receiving network node happens to be positioned at a −45 degree angle with respect to the V channel, then in such cases, the receiving network node will not receive any signal, as the received electric field would be orthogonal to the antenna. Additionally, or alternatively, some repeaters may receive signals using one polarization (e.g., H) and forward the signals using another polarization. However, if only one linear polarization is transmitted, in some examples, the receiving network node may not receive any signal if the received electric field is orthogonal to the antenna.

Accordingly, in some aspects, a repeater may forward a signal using a circular polarization type (e.g., a clockwise circular polarization type or a counterclockwise circular polarization type). A receiving network node may receive a signal transmitted with a circular polarization type using a linear antenna configuration without a risk of the signal being orthogonal to the linear antenna configuration, and therefore not received by the receiving network node. In some aspects, a repeater may report (e.g., to a control entity such as a network entity in backhaul, Uu, or sidelink mode 1, or a UE in sidelink mode 2) a capability of the repeater to forward signals using a set of one or more polarization types (e.g., including at least one circular polarization type), and in response the repeater may receive scheduling information indicating for the repeater to forward a signal in a given communication resource using a particular polarization type (e.g., a particular circular polarization type). The repeater may forward signals received in via a linear polarization type or a circular polarization type. The repeater may forward signals using a clockwise circular polarization type or a counterclockwise circular polarization type.

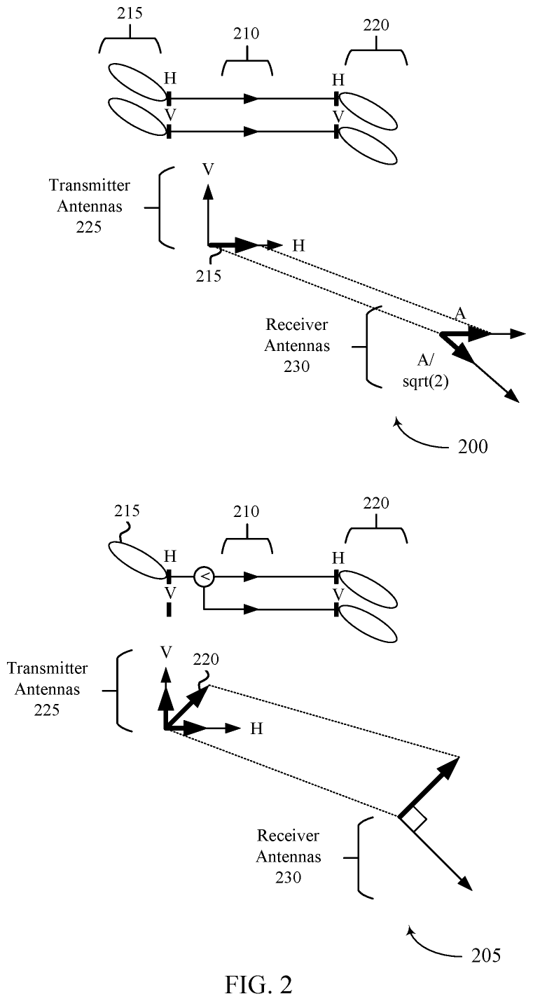

FIG. 2 illustrates an example of a repeater configuration 200 and a repeater configuration 205 that support repeaters with circular polarization in accordance with one or more aspects of the present disclosure. In some aspects, the repeater configuration 200 and a repeater configuration 205 may implement aspects of wireless communications systems 100.

In some cases, one channel (e.g., the V channel) between a transmitting device and the receiving device may be deeply faded. For example, the signal 215 received at the repeater 210 may have a deeply faded V channel. As shown in the repeater configuration 205, the repeater 210 may duplicate the received channel (e.g., the signal 215 received at the repeater 210) at H to forward the signal on both the V and H channels (e.g., as forwarded signal 220). In some cases, if receiver antennas 230 (e.g., an antenna of a receiving device (e.g., a UE 115 in downlink)) is slanted at −45 degrees with respect to the H channel of the transmitter antennas 225, then if the repeater 210 transmits the forwarded signal 220 over the H channel only, for example as shown in the repeater configuration 200, then the receiving device receives 1/√2 of the amplitude of the forwarded signal 220 due to the slant of the receiver antennas 230. If the repeater, however, forwards the forwarded signal 220 on the V channel as well, then the electric field of the forwarded signal 220 would be at +45 degrees and therefore perpendicular to the receiver antennas 230. Accordingly, the receiving device would not receive the forwarded signal 220.

Accordingly, as described herein, a repeater 210 may implement circular polarization when forwarding signals. For example, a repeater 210 may phase shift a signal 215 received by the repeater 210 by 90 degrees before forwarding the signal over the v channel. For example, the repeater may receive a signal using a single linear polarization and convert the signal to a circular polarized wave for forwarding. The receiver antennas 230 may pick (e.g., receive) the same signal, regardless of the rotation around an axis that is parallel to the propagation direction of the signal 215 forwarded by the repeater 210.

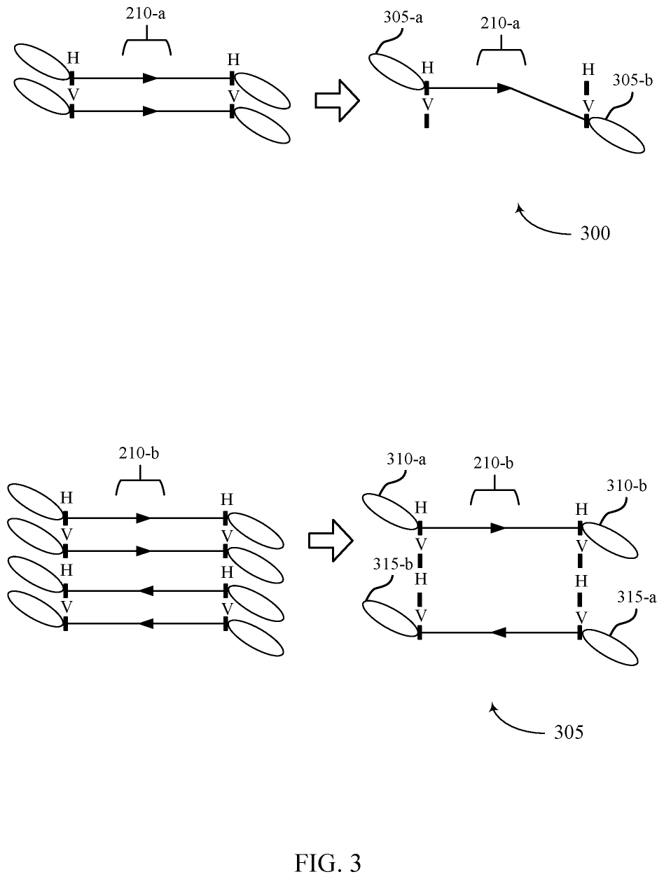

FIG. 3 illustrates an example of a repeater configuration 300 and a repeater configuration 305 that support repeaters with circular polarization in accordance with one or more aspects of the present disclosure. In some aspects, the repeater configuration 300 and a repeater configuration 305 may implement aspects of wireless communications systems 100.

Some wireless communications systems may implement a TDD repeater 210-a. A TDD repeater may receive a signal 305-a using one polarization (e.g., the H channel) and forward the signal 305-b after amplification on a different polarization (e.g., the V channel). Some wireless communications systems may implement a bidirectional repeater 210-b. A bidirectional repeater 210-b may use different polarizations for forwarding signals in different directions. For example, the bidirectional repeater 210-b may receive a downlink signal 310-a and forward the downlink signals 310-b using the H channel and may receive an uplink signal 315-a and forward the uplink signal 315-b using the V channel. TDD and bidirectional repeaters may reduce or avoid interference and self-oscillation.

In some cases, if a TDD repeater 210-a or a bidirectional repeater 210-b transmits one polarization (e.g., the V channel) to a receiving device (e.g., a UE 115), then a single-polarized receiving device may not receive the transmitted signal (depending on the rotation angle of the antenna of the receiving device). Measurements of reference signals at the receiving device and feedback to the repeater 210 may be used to avoid the possibility of missed signals at the receiving device. Use of reference signal measurements and feedback, however, may increase communications overhead and power consumption at the repeater and the receiving device, however.

As described herein, a repeater 210 may transmit (e.g., forward) a circular polarized wave, while a receiving device (e.g., a UE 115 in downlink or sidelink or a network entity 105 in uplink or backhaul) may use a linear polarized antenna configuration to receive the circular polarized wave. For example, a TDD repeater 210-a may receive signals (e.g., the signal 305-a) using one or clockwise or counter-clockwise circular polarization, and may forward the signals (e.g., the signal 305-b) using the other of clockwise or counter-clockwise polarization. As another example, a bidirectional repeater 210-b may forward a downlink signal 310-b using a different circular polarization than for an uplink signal 315-b (e.g., clockwise for downlink and counter-clockwise for uplink).

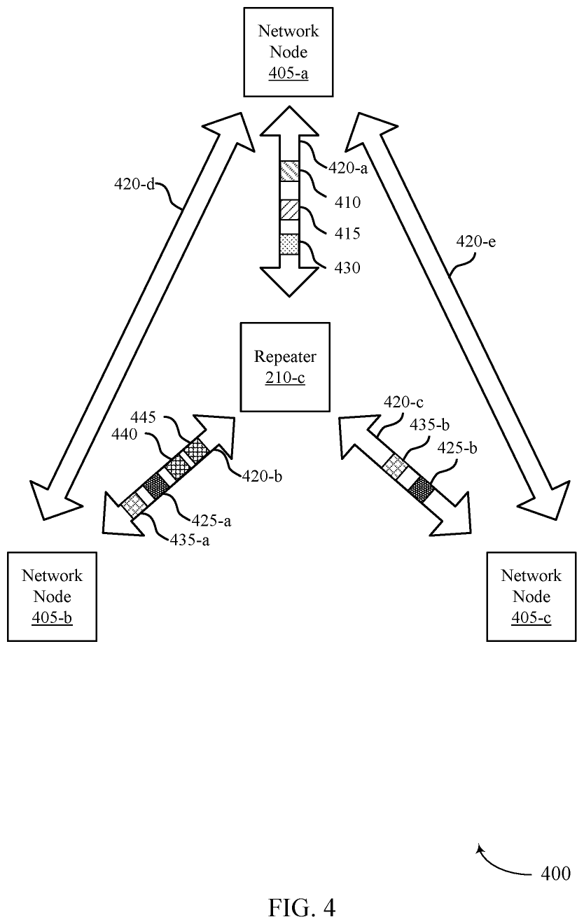

FIG. 4 illustrates an example of a wireless communications system 400 that supports repeaters with circular polarization in accordance with one or more aspects of the present disclosure. The wireless communications system 400 may implement aspects of wireless communications system 100, the repeater configuration 200, the repeater configuration 205, the repeater configuration 300, or the repeater configuration 305.

The repeater 210-c may be an example of a repeater 210 as described herein. The wireless communication system may include a first network node 405-a, a second network node 405-b, and a third network node 405-c. The repeater 210-c may forward signals received from the second network node 405-b to the third network node 405-c. For example, the repeater 210-c may receive signals from the second network node 405-b via a communication link 420-b, and the repeater 210-c may transmit (e.g., forward) signals to the third network node 405-c via a communication link 420-c. The first network node 405-a may be a control entity, which may schedule communications between the second network node 405-b, the third network node 405-c, and the repeater 210-c. The first network node 405-a may communicate with the repeater 210-c via a communication link 420-a, and the first network node 405-a may communicate with the second network node 405-b via a communication link 420-b and/or the third network node 405-c via a communication link 420-e. For example, the communication link 420-a, the communication link 420-b, the communication link 420-c, and/or the communication link 420-d may be examples of backhaul communication links 120, communication links 125, or D2D communications links 135 as described herein.

In some aspects, the first network node 405-a may be a same device as either the second network node 405-b or the third network node 405-c. For example, in downlink communications, the first network node 405-a may be a same network entity 105 as the second network node 405-b, and the repeater 210-c may forward downlink signals from the network entity 105 to a UE 115 (e.g., the third network node 405-c may be a UE 115 in downlink). As another example, in uplink communications, the first network node 405-a may be a same network entity 105 as the third network node 405-c, and the repeater 210-c may forward uplink signals from the UE (the second network node 405-b) to the third network node 405-c (e.g., the third network node 405-c may be a network entity 105 in uplink). As another example, in sidelink the first network node 405-a may be the same UE 115 as either the receiving UE 115 (e.g., the third network node 405-c) or the transmitting UE (e.g., the second network node 405-b). As another example, the repeater may forward sidelink signals transmitted by a transmitting UE 115 (e.g., the second network node 405-b) to a receiving UE (e.g., the third network node 405-c), and the first network node may be a controlling entity such as a network entity 105 in sidelink mode 1 or another UE in sidelink mode 2.

In some aspects, the repeater 210-c may receive a signal 425-a transmitted via a first circular polarization type (e.g., clockwise). For example, the second network node 405-b may transmit a baseband signal sp L (t) via circular (e.g., clockwise) polarization (e.g., the H and V components of the baseband signal s DL (t) may be given as x_{H}(t)=s_{DL}(t), and x_{V}(t)=j·S_{DL}(t), respectively. The received signal at the repeater may be given by r H (t) and r v (t), for the H and V components, respectively. The signal received by the repeater 210-c may accordingly be given by r(t)=r_{H}(t)—j·r_{V}(t). The repeater may amplify the received signal by an amplification factor, g, and accordingly, an amplified signal may be given by y(t)=g·r(t). The repeater 210-c may forward the amplified signal 425-b to the third network node 405-c using the same polarization type (e.g., clockwise circular polarization) as the received signal. For example, the H and V components of the amplified signal 425-b may be given by y_{H}(t)=y(t) and y_{V}(t)=j·y(t), respectively. In some examples, the repeater 210-c may reverse the type of circular polarization (e.g., from clockwise to counter-clockwise) prior to forwarding the amplified signal 425-b. For example, the repeater 210-c may multiply the V component by −j (negative imaginary 1) to change the circular polarization type from clockwise to counter-clockwise.

In some aspects, the repeater 210-c may receive a signal 425-a transmitted via a linear polarization type and may forward the received signal 425-a as an amplified signal 425-b using a circular polarization type (e.g., one of clockwise or counter-clockwise circular polarization). For example, the second network node 405-b may transmit a baseband signal s DL (t) via linear polarization. For example, the baseband signal may only have an H component, (e.g., x H (t)=s in (t)). In such examples, the received signal 425-a may be a linearly polarized signal (e.g., the signal received by the repeater 210-c may be given by r H (t). The repeater may amplify the received signal by an amplification factor, g, and accordingly, an amplified signal may be given by y(t)=g.r H (t). The repeater 210-c may convert the amplified signal to a circular (e.g., clockwise) polarized signal prior to forwarding the amplified signal 425-b (e.g., by transmitting on the V component j. y(t)). For example, the H and V components of the transmitted amplified signal 425-b may be given by y H (t)=y(t) and y v (t)=j. y(t), respectively.

In some aspects, the repeater may transmit control information 410 to the first network node 405-a indicating a capability of the first network node to support forwarding in accordance with a first set of one or more polarization types (e.g., including one or more circular polarization types). The first network node 405-a may transmit, based on the control information 410, scheduling information 415 to the repeater 210-c for a communication resource, where the scheduling information includes an indication to apply a particular polarization type of the first set of one or more polarization types to the communication resource. The repeater 210-c may receive the signal 425-a from the second network node 405-b and forward the signal 425-b via the communication resource in accordance with the scheduling information 415. In some examples, the first network node 405-a may also transmit scheduling information to the second network node 405-b (via the communication link 420-d) and/or the third network node 405-c (via the communication link 420-e) for the signal 425.

In some examples, the control information 410 may indicate whether the repeater 210-c supports receiving using a circular polarization type (e.g., one or both of clockwise or counterclockwise). In some aspects, the control information 410 may indicate whether the repeater 210-c supports forwarding using a circular polarization type (e.g., one or both of clockwise or counterclockwise). In some aspects, the control information 410 may indicate whether the repeater 210-c supports simultaneous reception and forwarding using different circular polarization types (e.g., receiving a signal 425-a via a first circular polarization type (e.g., one of clockwise or counter-clockwise) and forwarding the signal 425-b using a second circular polarization type (e.g., the other of clockwise or counter-clockwise)).

In some aspects, the control information 410 may indicate whether the repeater 210-c supports switching between different types of circular polarizations while forwarding signals (e.g., forwarding a first signal 425-b via a first circular polarization type (e.g., one of clockwise or counter-clockwise) and forwarding a subsequent signal 435-b using a second circular polarization type (e.g., the other of clockwise or counter-clockwise)). In some aspects, the control information 410 may indicate whether the repeater 210-c supports switching between different circular polarization and linear polarization while forwarding signals (e.g., forwarding a first signal 425-b via a circular polarization type (e.g., one of clockwise or counter-clockwise) and forwarding a subsequent signal 435-b using a linear polarization type). In some aspects, the first network node 405-a may transmit second scheduling information 430 scheduling the repeater to apply a second, different polarization type for a second, subsequent communication resource. For example, the scheduling information 415 may schedule the repeater 210-c to forward via a first communication resource using a first polarization type (e.g., one of a linear polarization type, a clockwise circular polarization type, or a counter-clockwise polarization type), and the second scheduling information 430 may schedule the repeater 210-c to forward via a subsequent second communication resource using a second polarization type different from the first polarization type (e.g., a different one of the linear polarization type, the clockwise circular polarization type, or the counter-clockwise polarization type). The repeater 210-c may receive the signal 425-a via the first communication resource and forward the signal 425-b using the first polarization type and the repeater 210-c may receive the signal 435-a via the second communication resource and forward the signal 435-b using the second polarization type.

In some aspects, the control information 410 may indicate a power configuration (e.g., in terms of maximum amplification gain and/or transmission power) per polarization type or per pair of polarizations (e.g., when switching between polarization types). In some aspects, the control information 410 may indicate internal delays at the repeater 210-c (e.g., for the different polarizations and/or switching modes). In some aspects, the control information 410 may indicate associated application latencies for various modes (e.g., the delay between the time the repeater 210-c receives a new command until implementing the indicated configuration). In some aspects, the control information 410 may indicate a switching latency between different modes (e.g., the latency of switching between different circular polarization types or between a circular polarization type and linear polarization.

In some aspects, the scheduling information 415 may indicate which type of circular polarization (e.g., clockwise or counter-clockwise) for receiving and forwarding a signal via a given communication resource (e.g., the communication resource corresponding to the signal 425). For example, the indication of which type of circular polarization may be for specific time, frequency, and/or spatial resources. In some aspects, the scheduling information 415 may indicate a power configuration for the repeater 210-c for the communication resource.

In some aspects, the repeater 210-c may be capable of determining a best circular polarization type (e.g., clockwise or counterclockwise) for the access or backhaul link of the repeater 210-c. The repeater 210-c may report the best circular polarization type (e.g., via the control information 410). For example, the repeater 210-c may generate measurement information on a first signal 440 received via a clockwise circular polarization type and a second signal 445 received via a counter-clockwise circular polarization type. The measurement information may be generated in the radio frequency domain, the intermediate frequency domain, or at baseband by measuring the reference signals (e.g., the first signal 440 and the second signal 445). The repeater 210-c may compare signal strengths of the first signal 440 and the second signal 445 based on the measurement information.

In some aspects, the repeater 210-c may be capable of determining a best polarization type (e.g., clockwise or counterclockwise) for the access or backhaul link of the repeater 210-c. based on a single signal (e.g., the first signal 440). For example, the repeater 210-c may receive a the first signal 440 on H and V channels, the H and V components of the signal being r H (t) and r v (t), respectively. The repeater 210-c may combine the first signal 440 signal in two different ways to generate measurement information, clockwise and counterclockwise. The measurement information may be generated in the radio frequency domain, the intermediate frequency domain, or at baseband. Combining the signal in clockwise manner gives a combined signal r c (t)=r_{H}(t)−j·r_{V}(t). Combining the signal in a counterclockwise manner gives a combined signal r_{CC}(t)=r_{H}(t)+j·r_{V}(t). The repeater 210-c may then generate measurement information for the strength of the two combinations (clockwise r_{C}(t), and counterclockwise r_{cc}(t)), and compare the strength of the two combinations to determine the better/stronger polarization type for amplification and forwarding.

In some aspects, the repeater 210-c may be unaware of which circular polarization will be used by the transmitter (e.g., the second network node 405-b). The repeater 210-c may measure signals transmitted by the transmitter (e.g., one or both of the first signal 440 or the second signal 445) and may determine a polarization type (e.g., linear, circular counterclockwise, or circular clockwise), and determine a polarization to forward the signals from the transmitter based on the determined polarization type.

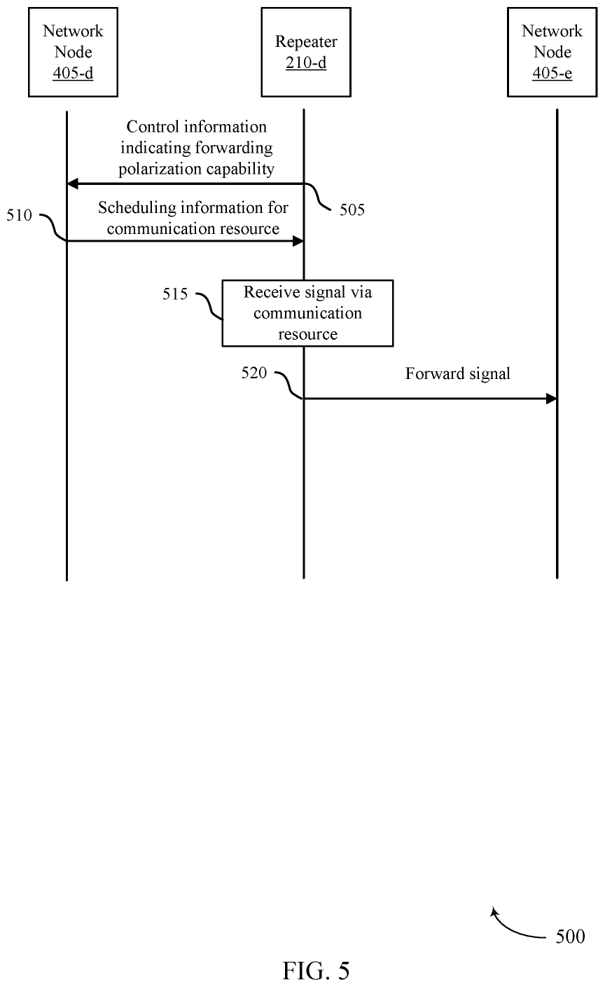

FIG. 5 illustrates an example of a process flow 500 that supports repeaters with circular polarization in accordance with one or more aspects of the present disclosure. The process flow 500 may include a first network node 405-d and a second network node 405-e, which may be examples of network nodes 405 as described herein. The process flow 500 may include a repeater 210-d, which may be an example of a repeater 210 as described herein. In the following description of the process flow 500, the operations between the first network node 405-d, the second network node 405-e, and the repeater 210-d may be transmitted in a different order than the example order shown, or the operations performed by the first network node 405-d, the second network node 405-e, and the repeater 210-d may be performed in different orders or at different times. Some operations may also be omitted from the process flow 500, and other operations may be added to the process flow 500.

At 505, the repeater 210-d may transmit control information including an indication of a capability of the repeater 210-d to support forwarding in accordance with a first set of one or more polarization types.

At 510, the repeater 210-d may receive from the first network node 405-d based on the control information, scheduling information for a communication resource, where the scheduling information includes an indication to apply a particular polarization type of the first set of one or more polarization types to the communication resource.

At 515, the repeater 210-d may receive a signal from another network node (e.g., either the first network node 405-d or another network node 405) for forwarding to the second network node 405-e.

At 520, the repeater 210-d may forward the signal received from the other network node via the communication resource to the second network node 405-e. In some aspects, the first network node 405-d may be the same entity as the second network node 405-e.

In some aspects, the one or more polarization types include at least one of a clockwise circular polarization and a counterclockwise circular polarization. In some aspects, the control information further includes an indication of a respective power configuration associated with each respective polarization type of the one or more polarization types.

In some aspects, at 515, the repeater 210-d may receive the signal in accordance with a particular polarization type of a second set of one or more polarization types, where the control information further includes an indication of a second capability of the repeater 210-d to support reception in accordance with the second set of one or more polarization types. In some aspects, the particular polarization type of the second set of one or more polarization types is different than the particular polarization type of the first set of one or more polarization types. In some aspects, the particular polarization type of the second set of one or more polarization types is the same as the particular polarization type of the first set of one or more polarization types.

In some aspects, at 515, the repeater 210-d may receive the signal in accordance with a first circular polarization type, and the particular polarization type of the first set of one or more polarization types may be a second circular polarization type different from the first circular polarization type. In some aspects, the control information further includes an indication of a second capability of the repeater 210-d to support simultaneous reception and forwarding of signals in accordance with different polarization types. In some aspects, the control information further includes an indication of a second capability of the first network node to support transmission in accordance with a second set of one or more polarization types. For example, forwarding refers to reception of a signal and then repeating/transmitting the signal, while some signals may be generated and transmitted by the repeater 210-d (e.g., a reference signal).

In some aspects, the control information further includes an indication of a second capability of the repeater 210-d to switch between forwarding in accordance with a first polarization type of the first set of one or more polarization types and forwarding in accordance with a second polarization type. In some aspects, the first polarization type is a circular polarization type and the second polarization type is a linear polarization type. In some aspects, the first polarization type is a linear polarization type and the second polarization type is a linear polarization type. In some aspects, the repeater 210-d may receive, from the first network node 405-d and based on the control information, second scheduling information for a second communication resource subsequent to the communication resource, where the second scheduling information includes an indication to apply the second polarization type to the second communication resource. In some aspects, the control information further includes an indication of a latency associated with a switch between forwarding in accordance with the first polarization type and forwarding in accordance with the second polarization type, and the scheduling information is based on the latency.

In some aspects, the control information further includes an indication of a set of one or more power configurations associated with the first set of one or more polarization types, and the scheduling information further includes an indication of a particular power configuration of the set of one or more power configurations to apply to the communication resource.

In some aspects, the repeater 210-d may receive a second signal from the second network node. The repeater 210-d may generate measurement information for a clockwise circular polarization type and a counterclockwise circular polarization type based on the second signal, and the control information may further include an indication of one of the clockwise circular polarization type or the counterclockwise circular polarization type. Receiving the signal at 515 may include receiving the signal in accordance with the one of the clockwise circular polarization type or the counterclockwise circular polarization type.

In some aspects, the repeater 210-d may determine a first circular polarization type of the signal received from the second network node, and the particular polarization type is a second circular polarization type determined based on the first circular polarization type.

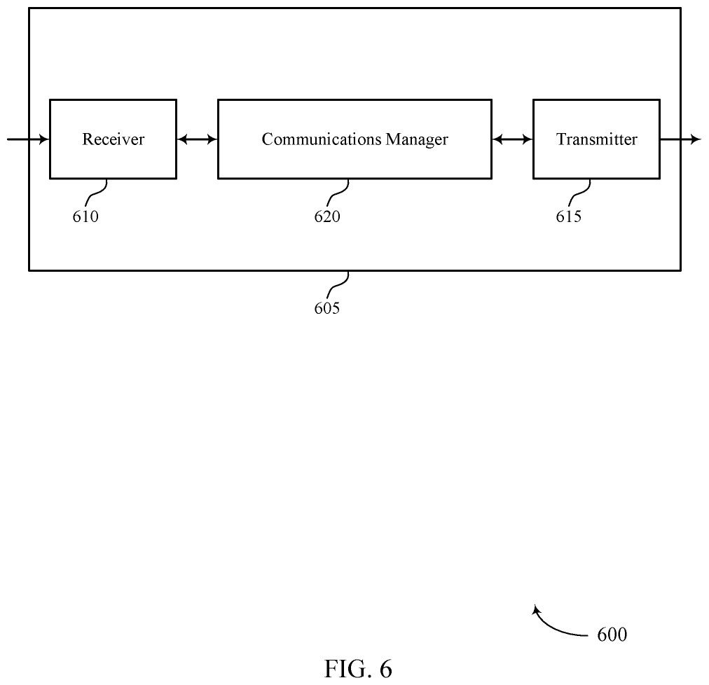

FIG. 6 shows a block diagram 600 of a device 605 that supports repeaters with circular polarization in accordance with one or more aspects of the present disclosure. The device 605 may be an example of aspects of a repeater 210 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to repeaters with circular polarization). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to repeaters with circular polarization). In some aspects, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of repeaters with circular polarization as described herein. For example, the communications manager 620, the receiver 610, the transmitter 615, or various combinations or components thereof may support a method for performing one or more of the functions described herein.

In some aspects, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a first network node in accordance with examples as disclosed herein. For example, the communications manager 620 may be configured as or otherwise support a means for transmitting control information including an indication of a capability of the first network node to support forwarding in accordance with a first set of one or more polarization types. The communications manager 620 may be configured as or otherwise support a means for receiving, based on the control information, scheduling information for a communication resource, where the scheduling information includes an indication to apply a particular polarization type of the first set of one or more polarization types to the communication resource. The communications manager 620 may be configured as or otherwise support a means for forwarding a signal received from a second network node via the communication resource to a third network node in accordance with the scheduling information.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for more efficient utilization of communication resources.

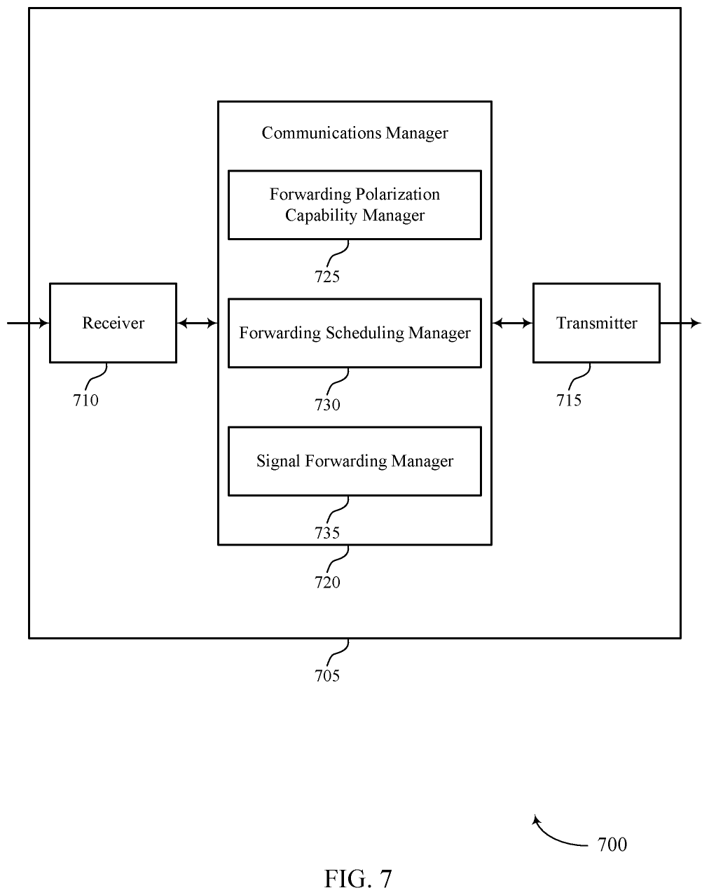

FIG. 7 shows a block diagram 700 of a device 705 that supports repeaters with circular polarization in accordance with one or more aspects of the present disclosure. The device 705 may be an example of aspects of a device 605 or a repeater 210 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to repeaters with circular polarization). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to repeaters with circular polarization). In some aspects, the transmitter 715 may be co-located with a receiver 710 in a transceiver module. The transmitter 715 may utilize a single antenna or a set of multiple antennas.

The device 705, or various components thereof, may be an example of means for performing various aspects of repeaters with circular polarization as described herein. For example, the communications manager 720 may include a forwarding polarization capability manager 725, a forwarding scheduling manager 730, a signal forwarding manager 735, or any combination thereof. The communications manager 720 may be an example of aspects of a communications manager 620 as described herein. In some aspects, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a first network node in accordance with examples as disclosed herein. The forwarding polarization capability manager 725 may be configured as or otherwise support a means for transmitting control information including an indication of a capability of the first network node to support forwarding in accordance with a first set of one or more polarization types. The forwarding scheduling manager 730 may be configured as or otherwise support a means for receiving, based on the control information, scheduling information for a communication resource, where the scheduling information includes an indication to apply a particular polarization type of the first set of one or more polarization types to the communication resource. The signal forwarding manager 735 may be configured as or otherwise support a means for forwarding a signal received from a second network node via the communication resource to a third network node in accordance with the scheduling information.

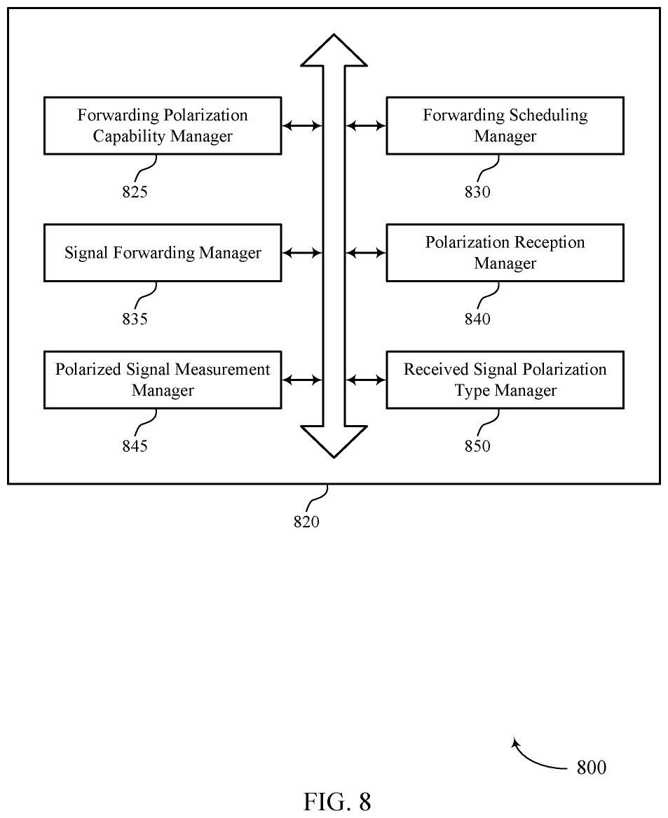

FIG. 8 shows a block diagram 800 of a communications manager 820 that supports repeaters with circular polarization in accordance with one or more aspects of the present disclosure. The communications manager 820 may be an example of aspects of a communications manager 620, a communications manager 720, or both, as described herein. The communications manager 820, or various components thereof, may be an example of means for performing various aspects of repeaters with circular polarization as described herein. For example, the communications manager 820 may include a forwarding polarization capability manager 825, a forwarding scheduling manager 830, a signal forwarding manager 835, a polarization reception manager 840, a polarized signal measurement manager 845, a received signal polarization type manager 850, or any combination thereof. Each of these components may communicate, directly or indirectly, with one another (e.g., via one or more buses).

The communications manager 820 may support wireless communications at a first network node in accordance with examples as disclosed herein. The forwarding polarization capability manager 825 may be configured as or otherwise support a means for transmitting control information including an indication of a capability of the first network node to support forwarding in accordance with a first set of one or more polarization types. The forwarding scheduling manager 830 may be configured as or otherwise support a means for receiving, based on the control information, scheduling information for a communication resource, where the scheduling information includes an indication to apply a particular polarization type of the first set of one or more polarization types to the communication resource. The signal forwarding manager 835 may be configured as or otherwise support a means for forwarding a signal received from a second network node via the communication resource to a third network node in accordance with the scheduling information.

In some aspects, the one or more polarization types include at least one of a clockwise circular polarization and a counterclockwise circular polarization.

In some aspects, the control information further includes an indication of a respective power configuration associated with each respective polarization type of the one or more polarization types.

In some aspects, the polarization reception manager 840 may be configured as or otherwise support a means for receive the signal in accordance with a particular polarization type of a second set of one or more polarization types, where the control information further includes an indication of a second capability of the first network node to support reception in accordance with the second set of one or more polarization types. In some aspects, the particular polarization type of the second set of one or more polarization types is different than the particular polarization type of the first set of one or more polarization types. In some aspects, the particular polarization type of the second set of one or more polarization types is the same as the particular polarization type of the first set of one or more polarization types.

In some aspects, the polarization reception manager 840 may be configured as or otherwise support a means for receiving the signal in accordance with a first circular polarization type, and where the particular polarization type of the first set of one or more polarization types includes a second circular polarization type different from the first circular polarization type.

In some aspects, the control information further includes an indication of a second capability of the first network node to support simultaneous reception and forwarding of signals in accordance with different polarization types. In some aspects, the control information further includes an indication of a second capability of the first network node to support transmission in accordance with a second set of one or more polarization types.

In some aspects, the control information further includes an indication of a second capability of the first network node to switch between forwarding in accordance with a first polarization type of the first set of one or more polarization types and forwarding in accordance with a second polarization type.

In some aspects, the first polarization type includes a circular polarization type and. In some aspects, the second polarization type includes a linear polarization type. In some aspects, the first polarization type is a linear polarization type and the second polarization type is a linear polarization type.

In some aspects, the forwarding scheduling manager 830 may be configured as or otherwise support a means for receiving, based on the control information, second scheduling information for a second communication resource subsequent to the communication resource, where the second scheduling information includes an indication to apply the second polarization type to the second communication resource.

In some aspects, the control information further includes an indication of a latency associated with a switch between forwarding in accordance with the first polarization type and forwarding in accordance with the second polarization type. In some aspects, the scheduling information is based on the latency.

In some aspects, the control information further includes an indication of a set of one or more power configurations associated with the first set of one or more polarization types. In some aspects, the scheduling information further includes an indication of a particular power configuration of the set of one or more power configurations to apply to the communication resource.

In some aspects, the polarization reception manager 840 may be configured as or otherwise support a means for receiving a second signal from the second network node. In some aspects, the polarized signal measurement manager 845 may be configured as or otherwise support a means for generating measurement information for a clockwise circular polarization type and a counterclockwise circular polarization type based on the second signal, where the control information further includes an indication of one of the clockwise circular polarization type or the counterclockwise circular polarization type, and where receiving the signal includes receiving the signal in accordance with the one of the clockwise circular polarization type or the counterclockwise circular polarization type.

In some aspects, the received signal polarization type manager 850 may be configured as or otherwise support a means for determining a first circular polarization type of the signal received from the second network node, where the particular polarization type includes a second circular polarization type determined based on the first circular polarization type.

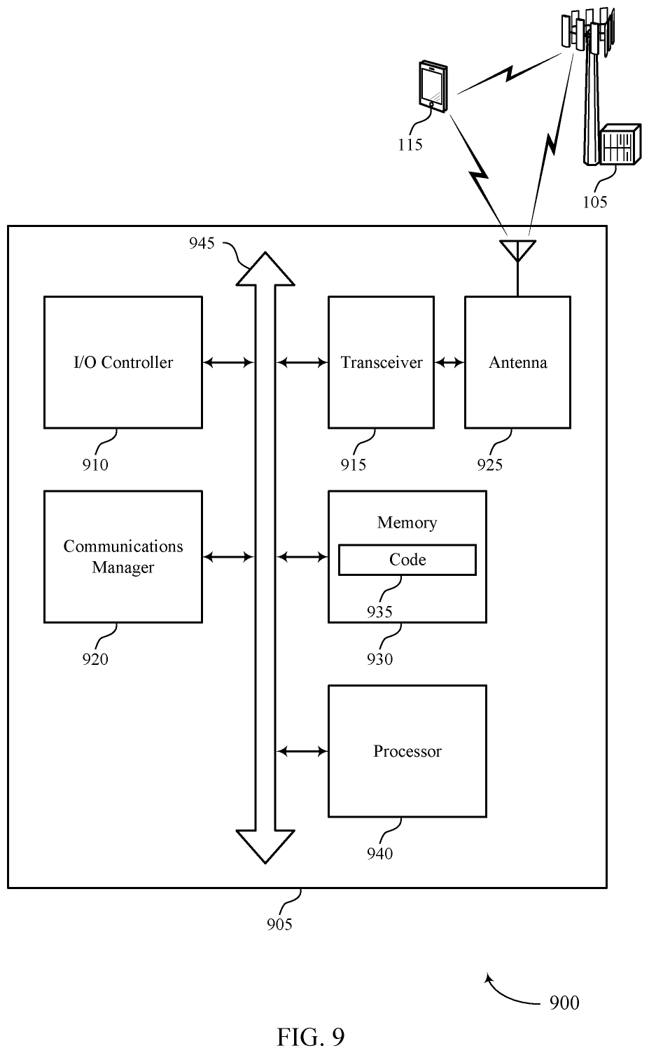

FIG. 9 shows a diagram of a system 900 including a device 905 that supports repeaters with circular polarization in accordance with one or more aspects of the present disclosure. The device 905 may be an example of or include the components of a device 605, a device 705, or a repeater as described herein. The device 905 may include components for bi-directional voice and data communications including components for transmitting and receiving communications, such as a communications manager 920, an I/O controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting repeaters with circular polarization). For example, the device 905 or a component of the device 905 may include a processor 940 and memory 930 coupled with or to the processor 940, the processor 940 and memory 930 configured to perform various functions described herein.

The communications manager 920 may support wireless communications at a first network node in accordance with examples as disclosed herein. For example, the communications manager 920 may be configured as or otherwise support a means for transmitting control information including an indication of a capability of the first network node to support forwarding in accordance with a first set of one or more polarization types. The communications manager 920 may be configured as or otherwise support a means for receiving, based on the control information, scheduling information for a communication resource, where the scheduling information includes an indication to apply a particular polarization type of the first set of one or more polarization types to the communication resource. The communications manager 920 may be configured as or otherwise support a means for forwarding a signal received from a second network node via the communication resource to a third network node in accordance with the scheduling information.

By including or configuring the communications manager 920 in accordance with examples as described herein, the device 905 may support techniques for more efficient utilization of communication resources and improved coordination between devices.

In some aspects, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some aspects, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of repeaters with circular polarization as described herein, or the processor 940 and the memory 930 may be otherwise configured to perform or support such operations.

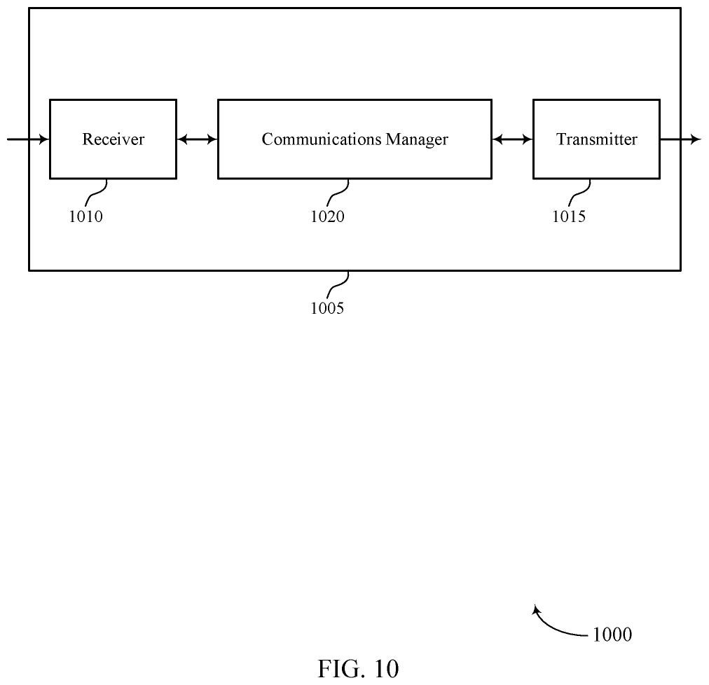

FIG. 10 shows a block diagram 1000 of a device 1005 that supports repeaters with circular polarization in accordance with one or more aspects of the present disclosure. The device 1005 may be an example of aspects of a UE 115 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for receiving information such as packets, user data, control information, or any combination thereof associated with various information channels (e.g., control channels, data channels, information channels related to repeaters with circular polarization). Information may be passed on to other components of the device 1005. The receiver 1010 may utilize a single antenna or a set of multiple antennas.

The transmitter 1015 may provide a means for transmitting signals generated by other components of the device 1005. For example, the transmitter 1015 may transmit information such as packets, user data, control information, or any combination thereof associated with various information channels (e.g., control channels, data channels, information channels related to repeaters with circular polarization). In some aspects, the transmitter 1015 may be co-located with a receiver 1010 in a transceiver module. The transmitter 1015 may utilize a single antenna or a set of multiple antennas.

The communications manager 1020, the receiver 1010, the transmitter 1015, or various combinations thereof or various components thereof may be examples of means for performing various aspects of repeaters with circular polarization as described herein. For example, the communications manager 1020, the receiver 1010, the transmitter 1015, or various combinations or components thereof may support a method for performing one or more of the functions described herein.

In some aspects, the communications manager 1020, the receiver 1010, the transmitter 1015, or various combinations or components thereof may be implemented in hardware (e.g., in communications management circuitry). The hardware may include a processor, a DSP, a CPU), an ASIC, an FPGA or other programmable logic device, a microcontroller, discrete gate or transistor logic, discrete hardware components, or any combination thereof configured as or otherwise supporting a means for performing the functions described in the present disclosure. In some aspects, a processor and memory coupled with the processor may be configured to perform one or more of the functions described herein (e.g., by executing, by the processor, instructions stored in the memory).

Additionally, or alternatively, in some aspects, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some aspects, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a first network node in accordance with examples as disclosed herein. For example, the communications manager 1020 may be configured as or otherwise support a means for receiving, from a second network node, control information including an indication of a capability of the second network node to support forwarding in accordance with a first set of one or more polarization types. The communications manager 1020 may be configured as or otherwise support a means for transmitting, to the second network node and based on the control information, scheduling information for a communication resource, where the scheduling information includes an indication to apply a particular polarization type of the first set of one or more polarization types to the communication resource.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for more efficient utilization of communication resources.

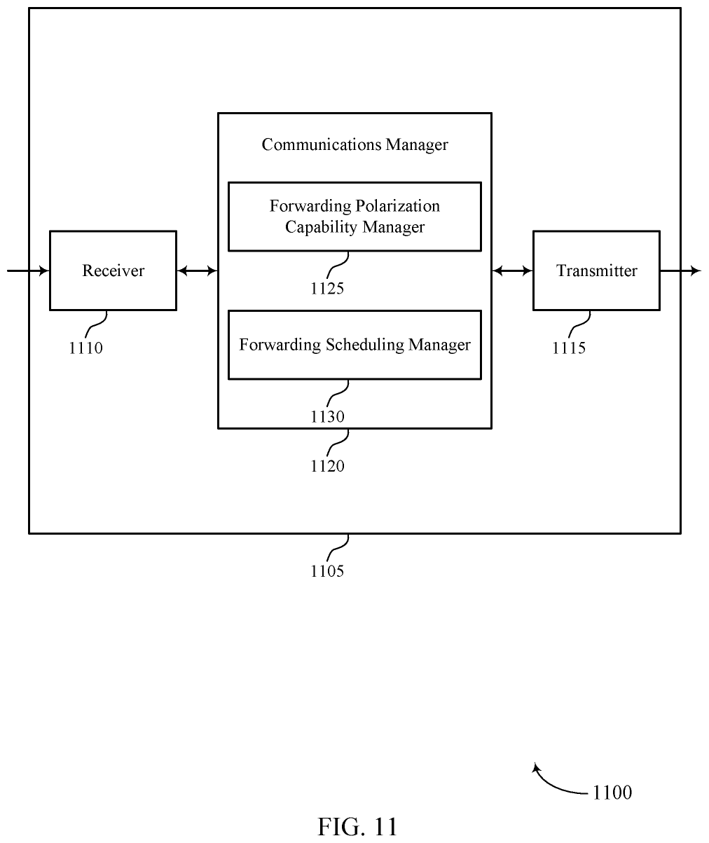

FIG. 11 shows a block diagram 1100 of a device 1105 that supports repeaters with circular polarization in accordance with one or more aspects of the present disclosure. The device 1105 may be an example of aspects of a device 1005, a UE 115, or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for receiving information such as packets, user data, control information, or any combination thereof associated with various information channels (e.g., control channels, data channels, information channels related to repeaters with circular polarization). Information may be passed on to other components of the device 1105. The receiver 1110 may utilize a single antenna or a set of multiple antennas.

The transmitter 1115 may provide a means for transmitting signals generated by other components of the device 1105. For example, the transmitter 1115 may transmit information such as packets, user data, control information, or any combination thereof associated with various information channels (e.g., control channels, data channels, information channels related to repeaters with circular polarization). In some aspects, the transmitter 1115 may be co-located with a receiver 1110 in a transceiver module. The transmitter 1115 may utilize a single antenna or a set of multiple antennas.

The device 1105, or various components thereof, may be an example of means for performing various aspects of repeaters with circular polarization as described herein. For example, the communications manager 1120 may include a forwarding polarization capability manager 1125 a forwarding scheduling manager 1130, or any combination thereof. The communications manager 1120 may be an example of aspects of a communications manager 1020 as described herein. In some aspects, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a first network node in accordance with examples as disclosed herein. The forwarding polarization capability manager 1125 may be configured as or otherwise support a means for receiving, from a second network node, control information including an indication of a capability of the second network node to support forwarding in accordance with a first set of one or more polarization types. The forwarding scheduling manager 1130 may be configured as or otherwise support a means for transmitting, to the second network node and based on the control information, scheduling information for a communication resource, where the scheduling information includes an indication to apply a particular polarization type of the first set of one or more polarization types to the communication resource.

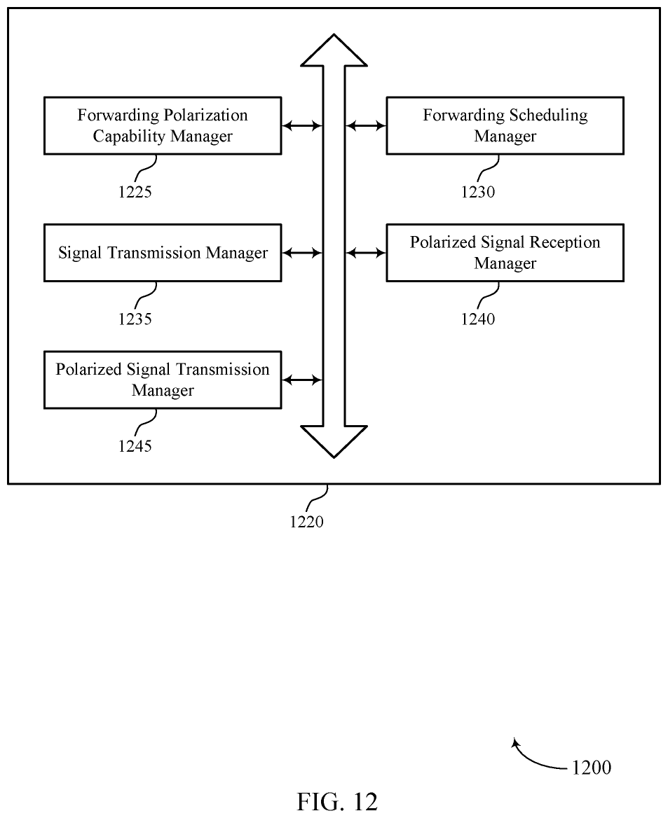

FIG. 12 shows a block diagram 1200 of a communications manager 1220 that supports repeaters with circular polarization in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of repeaters with circular polarization as described herein. For example, the communications manager 1220 may include a forwarding polarization capability manager 1225, a forwarding scheduling manager 1230, a signal transmission manager 1235, a polarized signal reception manager 1240, a polarized signal transmission manager 1245, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a first network node in accordance with examples as disclosed herein. The forwarding polarization capability manager 1225 may be configured as or otherwise support a means for receiving, from a second network node, control information including an indication of a capability of the second network node to support forwarding in accordance with a first set of one or more polarization types. The forwarding scheduling manager 1230 may be configured as or otherwise support a means for transmitting, to the second network node and based on the control information, scheduling information for a communication resource, where the scheduling information includes an indication to apply a particular polarization type of the first set of one or more polarization types to the communication resource.

In some aspects, the signal transmission manager 1235 may be configured as or otherwise support a means for transmitting a signal to the second network node via the communication resource for forwarding to a third network node.

In some aspects, the polarized signal transmission manager 1245 may be configured as or otherwise support a means for transmitting the signal in accordance with a first circular polarization type, where the particular polarization type includes a second circular polarization type different from the first circular polarization type.

In some aspects, the control information further includes an indication of a second capability of the second network node to support simultaneous reception and forwarding of signals in accordance with different polarization types.

In some aspects, the polarized signal transmission manager 1245 may be configured as or otherwise support a means for transmitting a second signal, where the control information further includes an indication of a selected one of a clockwise circular polarization type or a counterclockwise circular polarization type, and where transmitting the signal includes transmitting the signal in accordance with the selected one of the clockwise circular polarization type or the counterclockwise circular polarization type.

In some aspects, the polarized signal reception manager 1240 may be configured as or otherwise support a means for receiving a signal from the second network node via the communication resource in accordance with the particular polarization type.

In some aspects, the one or more polarization types include at least one of a clockwise circular polarization and a counterclockwise circular polarization.

In some aspects, the control information further includes an indication of a respective power configuration associated with each respective polarization type of the one or more polarization types.

In some aspects, the control information further includes an indication of a second capability of the second network node to support reception in accordance with a second set of one or more polarization types. In some aspects, the control information further includes an indication of a second capability of the second network node to support transmission in accordance with a second set of one or more polarization types.

In some aspects, the control information further includes an indication of a second capability of the second network node to switch between forwarding in accordance with a first polarization type of the first set of one or more polarization types and forwarding in accordance with a second polarization type.

In some aspects, the first polarization type includes a circular polarization type and the second polarization type includes a linear polarization type. In some aspects, the first polarization type includes a linear polarization type and the second polarization type includes a circular polarization type.

In some aspects, the forwarding scheduling manager 1230 may be configured as or otherwise support a means for transmitting, based on the control information, second scheduling information for a second communication resource subsequent to the communication resource, where the second scheduling information includes an indication to apply the second polarization type to the second communication resource.

In some aspects, the control information further includes an indication of a latency associated with a switch between forwarding in accordance with the first polarization type and forwarding in accordance with the second polarization type. In some aspects, the scheduling information is based on the latency.

In some aspects, the control information further includes an indication of a set of one or more power configurations associated with the first set of one or more polarization types. In some aspects, the scheduling information further includes an indication of a particular power configuration of the set of one or more power configurations to apply to the communication resource. In some aspects, the control information further includes an indication of a set of one or more power configurations associated with the first set of one or more polarization types. In some aspects, the scheduling information further includes an indication of a particular power configuration of the set of one or more power configurations to apply to the communication resource.

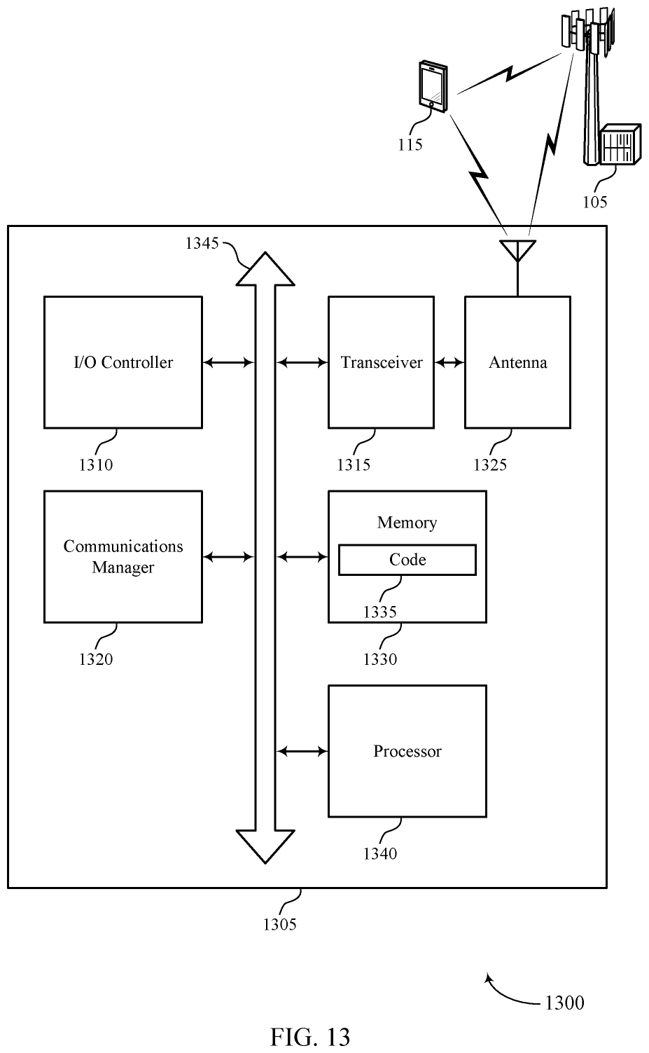

FIG. 13 shows a diagram of a system 1300 including a device 1305 that supports repeaters with circular polarization in accordance with one or more aspects of the present disclosure. The device 1305 may be an example of or include the components of a device 1005, a device 1105, or a UE 115 as described herein. The device 1305 may communicate (e.g., wirelessly) with one or more network entities 105, one or more UEs 115, or any combination thereof. The device 1305 may include components for bi-directional voice and data communications including components for transmitting and receiving communications, such as a communications manager 1320, an input/output (I/O) controller 1310, a transceiver 1315, an antenna 1325, a memory 1330, code 1335, and a processor 1340. These components may be in electronic communication or otherwise coupled (e.g., operatively, communicatively, functionally, electronically, electrically) via one or more buses (e.g., a bus 1345).

The I/O controller 1310 may manage input and output signals for the device 1305. The I/O controller 1310 may also manage peripherals not integrated into the device 1305. In some cases, the I/O controller 1310 may represent a physical connection or port to an external peripheral. In some cases, the I/O controller 1310 may utilize an operating system such as iOS®, ANDROID®, MS-DOS®, MS-WINDOWS®, OS/2®, UNIX®, LINUX®, or another known operating system. Additionally, or alternatively, the I/O controller 1310 may represent or interact with a modem, a keyboard, a mouse, a touchscreen, or a similar device. In some cases, the I/O controller 1310 may be implemented as part of a processor, such as the processor 1340. In some cases, a user may interact with the device 1305 via the I/O controller 1310 or via hardware components controlled by the I/O controller 1310.

In some cases, the device 1305 may include a single antenna 1325. However, in some other cases, the device 1305 may have more than one antenna 1325, which may be capable of concurrently transmitting or receiving multiple wireless transmissions. The transceiver 1315 may communicate bi-directionally, via the one or more antennas 1325, wired, or wireless links as described herein. For example, the transceiver 1315 may represent a wireless transceiver and may communicate bi-directionally with another wireless transceiver. The transceiver 1315 may also include a modem to modulate the packets, to provide the modulated packets to one or more antennas 1325 for transmission, and to demodulate packets received from the one or more antennas 1325. The transceiver 1315, or the transceiver 1315 and one or more antennas 1325, may be an example of a transmitter 1015, a transmitter 1115, a receiver 1010, a receiver 1110, or any combination thereof or component thereof, as described herein.

The memory 1330 may include RAM and ROM. The memory 1330 may store computer-readable, computer-executable code 1335 including instructions that, when executed by the processor 1340, cause the device 1305 to perform various functions described herein. The code 1335 may be stored in a non-transitory computer-readable medium such as system memory or another type of memory. In some cases, the code 1335 may not be directly executable by the processor 1340 but may cause a computer (e.g., when compiled and executed) to perform functions described herein. In some cases, the memory 1330 may contain, among other things, a BIOS which may control basic hardware or software operation such as the interaction with peripheral components or devices.

The processor 1340 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1340 may be configured to operate a memory array using a memory controller. In some other cases, a memory controller may be integrated into the processor 1340. The processor 1340 may be configured to execute computer-readable instructions stored in a memory (e.g., the memory 1330) to cause the device 1305 to perform various functions (e.g., functions or tasks supporting repeaters with circular polarization). For example, the device 1305 or a component of the device 1305 may include a processor 1340 and memory 1330 coupled with or to the processor 1340, the processor 1340 and memory 1330 configured to perform various functions described herein.

The communications manager 1320 may support wireless communications at a first network node in accordance with examples as disclosed herein. For example, the communications manager 1320 may be configured as or otherwise support a means for receiving, from a second network node, control information including an indication of a capability of the second network node to support forwarding in accordance with a first set of one or more polarization types. The communications manager 1320 may be configured as or otherwise support a means for transmitting, to the second network node and based on the control information, scheduling information for a communication resource, where the scheduling information includes an indication to apply a particular polarization type of the first set of one or more polarization types to the communication resource.

By including or configuring the communications manager 1320 in accordance with examples as described herein, the device 1305 may support techniques for more efficient utilization of communication resources and improved coordination between devices.

In some aspects, the communications manager 1320 may be configured to perform various operations (e.g., receiving, monitoring, transmitting) using or otherwise in cooperation with the transceiver 1315, the one or more antennas 1325, or any combination thereof. Although the communications manager 1320 is illustrated as a separate component, in some aspects, one or more functions described with reference to the communications manager 1320 may be supported by or performed by the processor 1340, the memory 1330, the code 1335, or any combination thereof. For example, the code 1335 may include instructions executable by the processor 1340 to cause the device 1305 to perform various aspects of repeaters with circular polarization as described herein, or the processor 1340 and the memory 1330 may be otherwise configured to perform or support such operations.

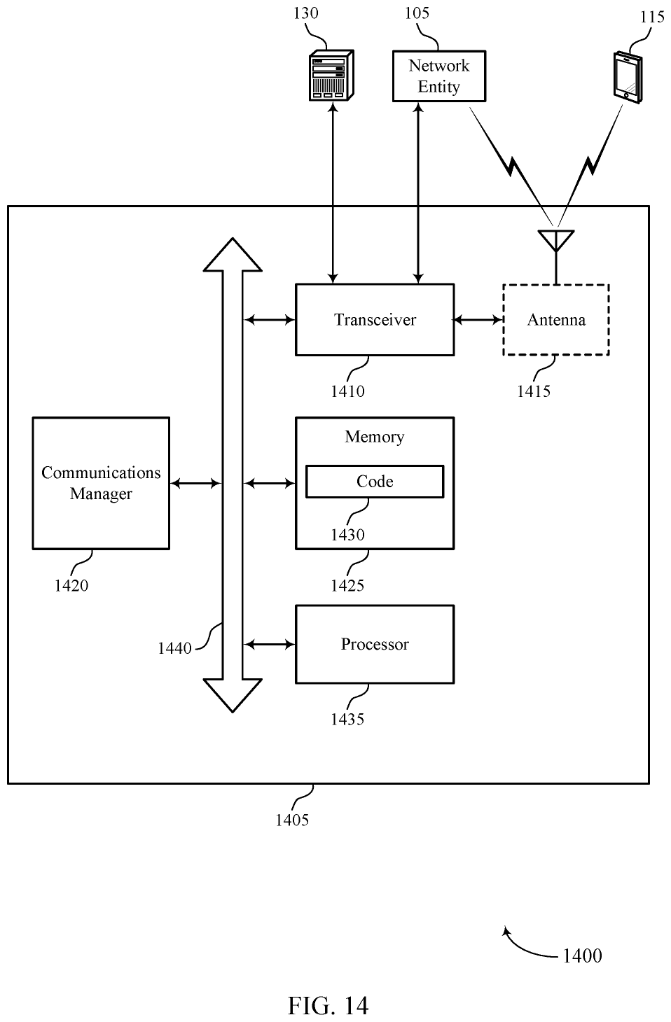

FIG. 14 shows a diagram of a system 1400 including a device 1405 that supports repeaters with circular polarization in accordance with one or more aspects of the present disclosure. The device 1405 may be an example of or include the components of a device 1005, a device 1105, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some aspects, the transceiver 1410 may include a wired transceiver and may communicate bi-directionally with another wired transceiver. Additionally, or alternatively, in some aspects, the transceiver 1410 may include a wireless transceiver and may communicate bi-directionally with another wireless transceiver. In some aspects, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or memory components (for example, the processor 1435, or the memory 1425, or both), may be included in a chip or chip assembly that is installed in the device 1405. In some aspects, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting repeaters with circular polarization). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405. The processor 1435 may be any one or more suitable processors capable of executing scripts or instructions of one or more software programs stored in the device 1405 (such as within the memory 1425). In some implementations, the processor 1435 may be a component of a processing system. A processing system may generally refer to a system or series of machines or components that receives inputs and processes the inputs to produce a set of outputs (which may be passed to other systems or components of, for example, the device 1405). For example, a processing system of the device 1405 may refer to a system including the various other components or subcomponents of the device 1405, such as the processor 1435, or the transceiver 1410, or the communications manager 1420, or other components or combinations of components of the device 1405. The processing system of the device 1405 may interface with other components of the device 1405, and may process information received from other components (such as inputs or signals) or output information to other components. For example, a chip or modem of the device 1405 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1405 may transmit information output from the chip or modem. Additionally, or alternatively, in some implementations, the one or more interfaces may refer to an interface between the processing system of the chip or modem and a receiver, such that the device 1405 may obtain information or signal inputs, and the information may be passed to the processing system. A person having ordinary skill in the art will readily recognize that a first interface also may obtain information or signal inputs, and a second interface also may output information or signal outputs.

In some aspects, a bus 1440 may support communications of (e.g., within) a protocol layer of a protocol stack. In some aspects, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some aspects, the communications manager 1420 may manage aspects of communications with a core network 130 (e.g., via one or more wired or wireless backhaul links). For example, the communications manager 1420 may manage the transfer of data communications for client devices, such as one or more UEs 115. In some aspects, the communications manager 1420 may manage communications with other network entities 105, and may include a controller or scheduler for controlling communications with UEs 115 in cooperation with other network entities 105. In some aspects, the communications manager 1420 may support an X2 interface within an LTE/LTE-A wireless communications network technology to provide communication between network entities 105.

The communications manager 1420 may support wireless communications at a first network node in accordance with examples as disclosed herein. For example, the communications manager 1420 may be configured as or otherwise support a means for receiving, from a second network node, control information including an indication of a capability of the second network node to support forwarding in accordance with a first set of one or more polarization types. The communications manager 1420 may be configured as or otherwise support a means for transmitting, to the second network node and based on the control information, scheduling information for a communication resource, where the scheduling information includes an indication to apply a particular polarization type of the first set of one or more polarization types to the communication resource.

By including or configuring the communications manager 1420 in accordance with examples as described herein, the device 1405 may support techniques for more efficient utilization of communication resources and improved coordination between devices.

In some aspects, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some aspects, one or more functions described with reference to the communications manager 1420 may be supported by or performed by the transceiver 1410, the processor 1435, the memory 1425, the code 1430, or any combination thereof. For example, the code 1430 may include instructions executable by the processor 1435 to cause the device 1405 to perform various aspects of repeaters with circular polarization as described herein, or the processor 1435 and the memory 1425 may be otherwise configured to perform or support such operations.

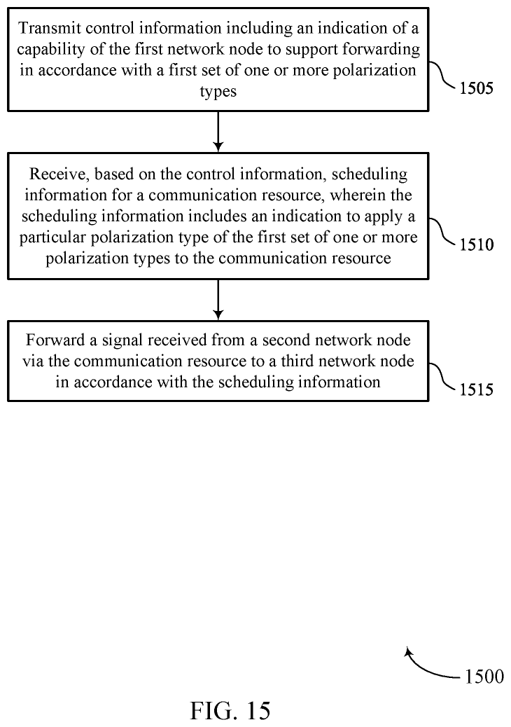

FIG. 15 shows a flowchart illustrating a method 1500 that supports repeaters with circular polarization in accordance with one or more aspects of the present disclosure. The operations of the method 1500 may be implemented by a repeater or its components as described herein. For example, the operations of the method 1500 may be performed by a repeater as described with reference to FIGS. 1 through 9. In some aspects, a repeater may execute a set of instructions to control the functional elements of the repeater to perform the described functions. Additionally, or alternatively, the repeater may perform aspects of the described functions using special-purpose hardware.

At 1505, the method may include transmitting control information including an indication of a capability of the first network node to support forwarding in accordance with a first set of one or more polarization types. The operations of 1505 may be performed in accordance with examples as disclosed herein. In some aspects, aspects of the operations of 1505 may be performed by a forwarding polarization capability manager 825 as described with reference to FIG. 8.

At 1510, the method may include receiving, based on the control information, scheduling information for a communication resource, where the scheduling information includes an indication to apply a particular polarization type of the first set of one or more polarization types to the communication resource. The operations of 1510 may be performed in accordance with examples as disclosed herein. In some aspects, aspects of the operations of 1510 may be performed by a forwarding scheduling manager 830 as described with reference to FIG. 8.

At 1515, the method may include forwarding a signal received from a second network node via the communication resource to a third network node in accordance with the scheduling information. The operations of 1515 may be performed in accordance with examples as disclosed herein. In some aspects, aspects of the operations of 1515 may be performed by a signal forwarding manager 835 as described with reference to FIG. 8.

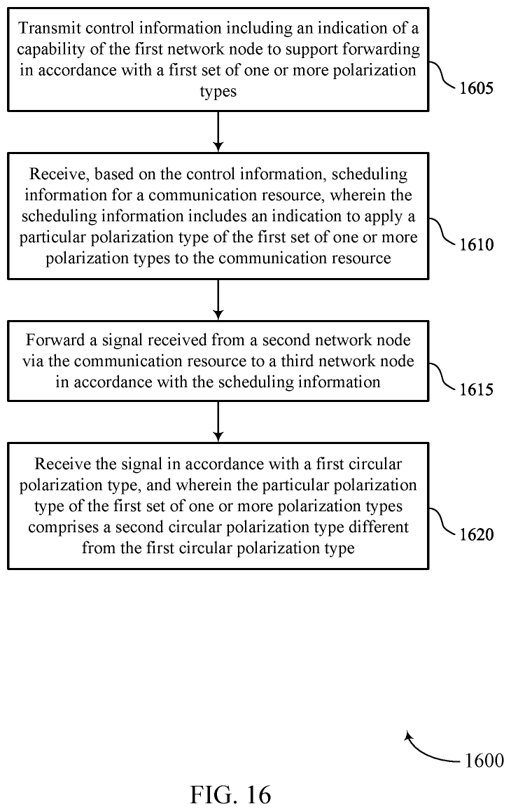

FIG. 16 shows a flowchart illustrating a method 1600 that supports repeaters with circular polarization in accordance with one or more aspects of the present disclosure. The operations of the method 1600 may be implemented by a repeater or its components as described herein. For example, the operations of the method 1600 may be performed by a repeater as described with reference to FIGS. 1 through 9. In some aspects, a repeater may execute a set of instructions to control the functional elements of the repeater to perform the described functions. Additionally, or alternatively, the repeater may perform aspects of the described functions using special-purpose hardware.

At 1605, the method may include transmitting control information including an indication of a capability of the first network node to support forwarding in accordance with a first set of one or more polarization types. The operations of 1605 may be performed in accordance with examples as disclosed herein. In some aspects, aspects of the operations of 1605 may be performed by a forwarding polarization capability manager 825 as described with reference to FIG. 8.

At 1610, the method may include receiving, based on the control information, scheduling information for a communication resource, where the scheduling information includes an indication to apply a particular polarization type of the first set of one or more polarization types to the communication resource. The operations of 1610 may be performed in accordance with examples as disclosed herein. In some aspects, aspects of the operations of 1610 may be performed by a forwarding scheduling manager 830 as described with reference to FIG. 8.

At 1615, the method may include forwarding a signal received from a second network node via the communication resource to a third network node in accordance with the scheduling information. The operations of 1615 may be performed in accordance with examples as disclosed herein. In some aspects, aspects of the operations of 1615 may be performed by a signal forwarding manager 835 as described with reference to FIG. 8.

At 1620, the method may include receiving the signal in accordance with a first circular polarization type, and where the particular polarization type of the first set of one or more polarization types includes a second circular polarization type different from the first circular polarization type. The operations of 1620 may be performed in accordance with examples as disclosed herein. In some aspects, aspects of the operations of 1620 may be performed by a polarization reception manager 840 as described with reference to FIG. 8.

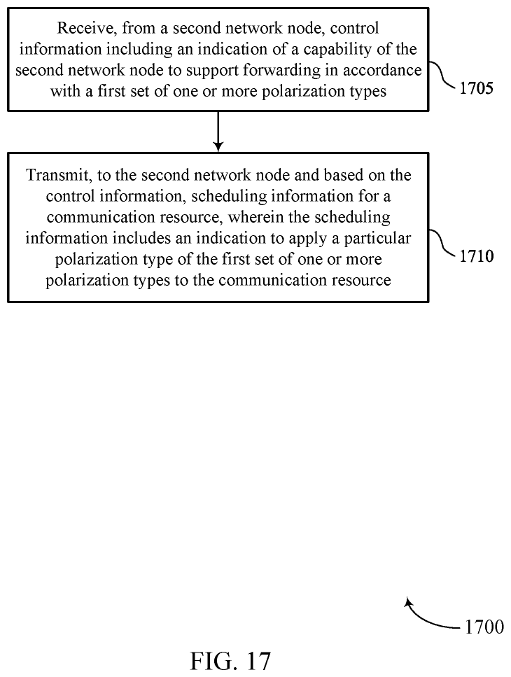

FIG. 17 shows a flowchart illustrating a method 1700 that supports repeaters with circular polarization in accordance with one or more aspects of the present disclosure. The operations of the method 1700 may be implemented by a UE or a network entity or its components as described herein. For example, the operations of the method 1700 may be performed by a UE 115 or a network entity as described with reference to FIGS. 1 through 5 and 10 through 14. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1705, the method may include receiving, from a second network node, control information including an indication of a capability of the second network node to support forwarding in accordance with a first set of one or more polarization types. The operations of 1705 may be performed in accordance with examples as disclosed herein. In some aspects, aspects of the operations of 1705 may be performed by a forwarding polarization capability manager 1225 as described with reference to FIG. 12.

At 1710, the method may include transmitting, to the second network node and based on the control information, scheduling information for a communication resource, where the scheduling information includes an indication to apply a particular polarization type of the first set of one or more polarization types to the communication resource. The operations of 1710 may be performed in accordance with examples as disclosed herein. In some aspects, aspects of the operations of 1710 may be performed by a forwarding scheduling manager 1230 as described with reference to FIG. 12.

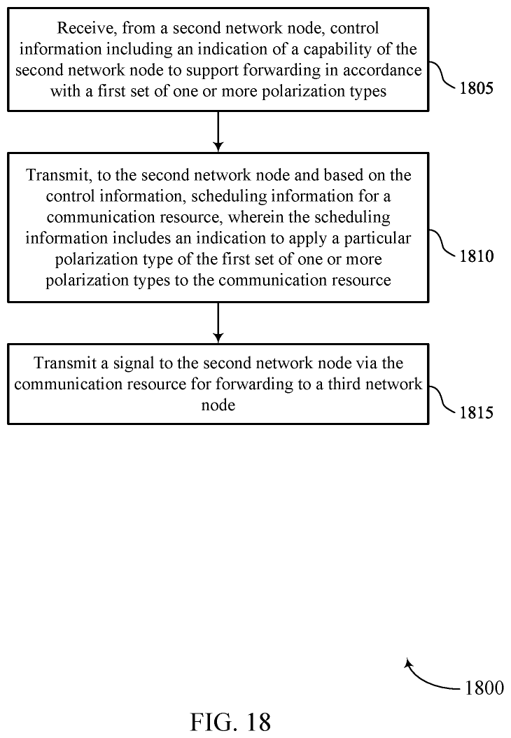

FIG. 18 shows a flowchart illustrating a method 1800 that supports repeaters with circular polarization in accordance with one or more aspects of the present disclosure. The operations of the method 1800 may be implemented by a UE or a network entity or its components as described herein. For example, the operations of the method 1800 may be performed by a UE 115 or a network entity as described with reference to FIGS. 1 through 5 and 10 through 14. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1805, the method may include receiving, from a second network node, control information including an indication of a capability of the second network node to support forwarding in accordance with a first set of one or more polarization types. The operations of 1805 may be performed in accordance with examples as disclosed herein. In some aspects, aspects of the operations of 1805 may be performed by a forwarding polarization capability manager 1225 as described with reference to FIG. 12.

At 1810, the method may include transmitting, to the second network node and based on the control information, scheduling information for a communication resource, where the scheduling information includes an indication to apply a particular polarization type of the first set of one or more polarization types to the communication resource. The operations of 1810 may be performed in accordance with examples as disclosed herein. In some aspects, aspects of the operations of 1810 may be performed by a forwarding scheduling manager 1230 as described with reference to FIG. 12.

At 1815, the method may include transmitting a signal to the second network node via the communication resource for forwarding to a third network node. The operations of 1815 may be performed in accordance with examples as disclosed herein. In some aspects, aspects of the operations of 1815 may be performed by a signal transmission manager 1235 as described with reference to FIG. 12.

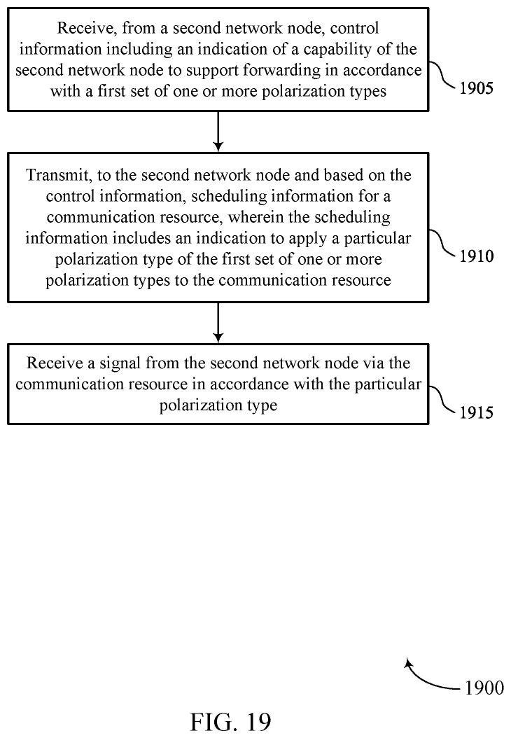

FIG. 19 shows a flowchart illustrating a method 1900 that supports repeaters with circular polarization in accordance with one or more aspects of the present disclosure. The operations of the method 1900 may be implemented by a UE or a network entity or its components as described herein. For example, the operations of the method 1900 may be performed by a UE 115 or a network entity as described with reference to FIGS. 1 through 5 and 10 through 14. In some aspects, a UE or a network entity may execute a set of instructions to control the functional elements of the UE or the network entity to perform the described functions. Additionally, or alternatively, the UE or the network entity may perform aspects of the described functions using special-purpose hardware.

At 1905, the method may include receiving, from a second network node, control information including an indication of a capability of the second network node to support forwarding in accordance with a first set of one or more polarization types. The operations of 1905 may be performed in accordance with examples as disclosed herein. In some aspects, aspects of the operations of 1905 may be performed by a forwarding polarization capability manager 1225 as described with reference to FIG. 12.

At 1910, the method may include transmitting, to the second network node and based on the control information, scheduling information for a communication resource, where the scheduling information includes an indication to apply a particular polarization type of the first set of one or more polarization types to the communication resource. The operations of 1910 may be performed in accordance with examples as disclosed herein. In some aspects, aspects of the operations of 1910 may be performed by a forwarding scheduling manager 1230 as described with reference to FIG. 12.

At 1915, the method may include receiving a signal from the second network node via the communication resource in accordance with the particular polarization type. The operations of 1915 may be performed in accordance with examples as disclosed herein. In some aspects, aspects of the operations of 1915 may be performed by a polarized signal reception manager 1240 as described with reference to FIG. 12. The following provides an overview of aspects of the present disclosure:

Aspect 1: A method for wireless communications at a first network node, comprising: transmitting control information including an indication of a capability of the first network node to support forwarding in accordance with a first set of one or more polarization types; receiving, based on the control information, scheduling information for a communication resource, wherein the scheduling information includes an indication to apply a particular polarization type of the first set of one or more polarization types to the communication resource; and forwarding a signal received from a second network node via the communication resource to a third network node in accordance with the scheduling information.

Aspect 2: The method of aspect 1, wherein the one or more polarization types include at least one of a clockwise circular polarization and a counterclockwise circular polarization.

Aspect 3: The method of aspect 2, wherein the control information further includes an indication of a respective power configuration associated with each respective polarization type of the one or more polarization types.

Aspect 4: The method of any of aspects 1 through 3, further comprising: receive the signal in accordance with a particular polarization type of a second set of one or more polarization types, wherein the control information further includes an indication of a second capability of the first network node to support reception in accordance with the second set of one or more polarization types.

Aspect 5: The method of aspect 4, wherein the particular polarization type of the second set of one or more polarization types is different than the particular polarization type of the first set of one or more polarization types.

Aspect 6: The method of aspect 4, wherein the particular polarization type of the second set of one or more polarization types is the same as the particular polarization type of the first set of one or more polarization types.

Aspect 7: The method of any of aspects 1 through 6, further comprising: receiving the signal in accordance with a first circular polarization type, and wherein the particular polarization type of the first set of one or more polarization types comprises a second circular polarization type different from the first circular polarization type.

Aspect 8: The method of aspect 7, wherein the control information further includes an indication of a second capability of the first network node to support simultaneous reception and forwarding of signals in accordance with different polarization types.

Aspect 9: The method of any of aspects 1 through 8, wherein the control information further includes an indication of a second capability of the first network node to support transmission in accordance with a second set of one or more polarization types.

Aspect 10: The method of any of aspects 1 through 9, wherein the control information further includes an indication of a second capability of the first network node to switch between forwarding in accordance with a first polarization type of the first set of one or more polarization types and forwarding in accordance with a second polarization type.

Aspect 11: The method of aspect 10, wherein the first polarization type comprises a circular polarization type and the second polarization type comprises a linear polarization type.

Aspect 12: The method of aspect 10, wherein the first polarization type comprises a linear polarization type and the second polarization type comprises a circular polarization type.

Aspect 13: The method of any of aspects 10 through 12, further comprising: receiving, based on the control information, second scheduling information for a second communication resource subsequent to the communication resource, wherein the second scheduling information includes an indication to apply the second polarization type to the second communication resource.

Aspect 14: The method of aspect 13, wherein the control information further includes an indication of a latency associated with a switch between forwarding in accordance with the first polarization type and forwarding in accordance with the second polarization type, and the scheduling information is based on the latency.

Aspect 15: The method of any of aspects 1 through 14, wherein the control information further includes an indication of a set of one or more power configurations associated with the first set of one or more polarization types, and the scheduling information further includes an indication of a particular power configuration of the set of one or more power configurations to apply to the communication resource.

Aspect 16: The method of any of aspects 1 through 15, further comprising: receiving a second signal from the second network node; generating measurement information for a clockwise circular polarization type and a counterclockwise circular polarization type based on the second signal, wherein the control information further includes an indication of one of the clockwise circular polarization type or the counterclockwise circular polarization type, and wherein receiving the signal comprises receiving the signal in accordance with the one of the clockwise circular polarization type or the counterclockwise circular polarization type.

Aspect 17: The method of any of aspects 1 through 16, further comprising: determining a first circular polarization type of the signal received from the second network node, wherein the particular polarization type comprises a second circular polarization type determined based on the first circular polarization type.

Aspect 18: A method for wireless communications at a first network node, comprising: receiving, from a second network node, control information including an indication of a capability of the second network node to support forwarding in accordance with a first set of one or more polarization types; and transmitting, to the second network node and based on the control information, scheduling information for a communication resource, wherein the scheduling information includes an indication to apply a particular polarization type of the first set of one or more polarization types to the communication resource.

Aspect 19: The method of aspect 18, further comprising: transmitting a signal to the second network node via the communication resource for forwarding to a third network node.

Aspect 20: The method of aspect 19, further comprising: transmitting the signal in accordance with a first circular polarization type, wherein the particular polarization type comprises a second circular polarization type different from the first circular polarization type.

Aspect 21: The method of aspect 20, wherein the control information further includes an indication of a second capability of the second network node to support simultaneous reception and forwarding of signals in accordance with different polarization types.

Aspect 22: The method of any of aspects 19 through 21, further comprising: transmitting a second signal to the second network node, wherein the control information further includes an indication of a selected one of a clockwise circular polarization type or a counterclockwise circular polarization type, and wherein transmitting the signal comprises transmitting the signal in accordance with the selected one of the clockwise circular polarization type or the counterclockwise circular polarization type.

Aspect 23: The method of any of aspects 18 through 22, further comprising: receiving a signal from the second network node via the communication resource in accordance with the particular polarization type.

Aspect 24: The method of any of aspects 18 through 23, wherein the one or more polarization types include at least one of a clockwise circular polarization and a counterclockwise circular polarization.

Aspect 25: The method of aspect 24, wherein the control information further includes an indication of a respective power configuration associated with each respective polarization type of the one or more polarization types.

Aspect 26: The method of any of aspects 18 through 25, wherein the control information further includes an indication of a second capability of the second network node to support reception in accordance with a second set of one or more polarization types.

Aspect 27: The method of any of aspects 18 through 26, wherein the control information further includes an indication of a second capability of the second network node to support transmission in accordance with a second set of one or more polarization types.

Aspect 28: The method of any of aspects 18 through 27, wherein the control information further includes an indication of a second capability of the second network node to switch between forwarding in accordance with a first polarization type of the first set of one or more polarization types and forwarding in accordance with a second polarization type.

Aspect 29: The method of aspect 28, wherein the first polarization type comprises a circular polarization type and the second polarization type comprises a linear polarization type.

Aspect 30: The method of aspect 28, wherein the first polarization type comprises a linear polarization type and the second polarization type comprises a circular polarization type.

Aspect 31: The method of any of aspects 28 through 30, further comprising: transmitting, based on the control information, second scheduling information for a second communication resource subsequent to the communication resource, wherein the second scheduling information includes an indication to apply the second polarization type to the second communication resource.

Aspect 32: The method of aspect 31, wherein the control information further includes an indication of a latency associated with a switch between forwarding in accordance with the first polarization type and forwarding in accordance with the second polarization type, and the scheduling information is based on the latency.

Aspect 33: The method of any of aspects 18 through 32, wherein the control information further includes an indication of a set of one or more power configurations associated with the first set of one or more polarization types, and the scheduling information further includes an indication of a particular power configuration of the set of one or more power configurations to apply to the communication resource, the control information further includes an indication of a set of one or more power configurations associated with the first set of one or more polarization types, and the scheduling information further includes an indication of a particular power configuration of the set of one or more power configurations to apply to the communication resource.

Aspect 34: A first network node for wireless communication, comprising: a memory; and at least one processor coupled to the memory, wherein the at least one processor is configured to perform a method of any of aspects 1 through 17.

Aspect 35: An apparatus for wireless communications at a first network node, comprising at least one means for performing a method of any of aspects 1 through 17.

Aspect 36: A non-transitory computer-readable medium having code for wireless communication stored thereon that, when executed by a network node, causes the network node to perform a method of any of aspects 1 through 17.

Aspect 37: A first network node for wireless communication, comprising: a memory; and at least one processor coupled to the memory, wherein the at least one processor is configured to perform a method of any of aspects 18 through 33.

Aspect 38: An apparatus for wireless communications at a first network node, comprising at least one means for performing a method of any of aspects 18 through 33.

Aspect 39: A non-transitory computer-readable medium having code for wireless communication stored thereon that, when executed by a network node, causes the network node to perform a method of any of aspects 18 through 33.

The methods described herein describe possible implementations, and that the operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, the term “or” is an inclusive “or” unless limiting language is used relative to the alternatives listed. For example, reference to “X being based on A or B” shall be construed as including within its scope X being based on A, X being based on B, and X being based on A and B. In this regard, reference to “X being based on A or B” refers to “at least one of A or B” or “one or more of A or B” due to “or” being inclusive. Similarly, reference to “X being based on A, B, or C” shall be construed as including within its scope X being based on A, X being based on B, X being based on C, X being based on A and B, X being based on A and C, X being based on B and C, and X being based on A, B, and C. In this regard, reference to “X being based on A, B, or C” refers to “at least one of A, B, or C” or “one or more of A, B, or C” due to “or” being inclusive. As an example of limiting language, reference to “X being based on only one of A or B” shall be construed as including within its scope X being based on A as well as X being based on B, but not X being based on A and B. Also, as used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently. Also, as used herein, the phrase “a set” shall be construed as including the possibility of a set with one member. That is, the phrase “a set” shall be construed in the same manner as “one or more” or “at least one of.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the drawings, describes example configurations and does not represent all the examples that may be implemented or that are within the scope of the claims. The term “aspect” or “example” used herein means “serving as an aspect, example, instance, or illustration,” and not “preferred” or “advantageous over other aspects.” The detailed description includes specific details for the purpose of providing an understanding of the described techniques. These techniques, however, may be practiced without these specific details. In some instances, structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A first network node for wireless communication, comprising:
a memory; and
at least one processor coupled to the memory, wherein the at least one processor is configured to:
transmit control information including an indication of a capability of the first network node to support forwarding in accordance with a first set of one or more polarization types;
receive, based on the control information, scheduling information for a communication resource, wherein the scheduling information includes an indication to apply a particular polarization type of the first set of one or more polarization types to the communication resource; and
forward a signal received from a second network node via the communication resource to a third network node in accordance with the scheduling information.

2. The first network node of claim 1, wherein the one or more polarization types include at least one of a clockwise circular polarization and a counterclockwise circular polarization.

3. The first network node of claim 2, wherein the control information further includes an indication of a respective power configuration associated with each respective polarization type of the one or more polarization types.

4. The first network node of claim 1, wherein the control information further includes an indication of a second capability of the first network node to support reception in accordance with a second set of one or more polarization types, and wherein the at least one processor is configured to:
receive the signal in accordance with a particular polarization type of the second set of one or more polarization types.

5. The first network node of claim 4, wherein the particular polarization type of the second set of one or more polarization types is different than the particular polarization type of the first set of one or more polarization types.

6. The first network node of claim 4, wherein the particular polarization type of the second set of one or more polarization types is the same as the particular polarization type of the first set of one or more polarization types.

7. The first network node of claim 1, wherein the at least one processor is configured to:
receive the signal in accordance with a first circular polarization type, and wherein the particular polarization type of the first set of one or more polarization types comprises a second circular polarization type different from the first circular polarization type.

8. The first network node of claim 7, wherein the control information further includes an indication of a second capability of the first network node to support simultaneous reception and forwarding of signals in accordance with different polarization types.

9. The first network node of claim 1, wherein the control information further includes an indication of a second capability of the first network node to support transmission in accordance with a second set of one or more polarization types.

10. The first network node of claim 1, wherein the control information further includes an indication of a second capability of the first network node to switch between forwarding in accordance with a first polarization type of the first set of one or more polarization types and forwarding in accordance with a second polarization type.

11. The first network node of claim 10, wherein the first polarization type comprises a circular polarization type and wherein the second polarization type comprises a linear polarization type.

12. The first network node of claim 10, wherein the first polarization type comprises a linear polarization type and wherein the second polarization type comprises a circular polarization type.

13. The first network node of claim 10, wherein the at least one processor is configured to:
receive, based on the control information, second scheduling information for a second communication resource subsequent to the communication resource, wherein the second scheduling information includes an indication to apply the second polarization type to the second communication resource.

14. The first network node of claim 13, wherein the control information further includes an indication of a latency associated with a switch between forwarding in accordance with the first polarization type and forwarding in accordance with the second polarization type, and wherein the scheduling information is based on the latency.

15. The first network node of claim 1, wherein the control information further includes an indication of a set of one or more power configurations associated with the first set of one or more polarization types, and wherein the scheduling information further includes an indication of a particular power configuration of the set of one or more power configurations to apply to the communication resource.

16. The first network node of claim 1, wherein the at least one processor is configured to:
receive a second signal from the second network node; and
generate measurement information for a clockwise circular polarization type and a counterclockwise circular polarization type based on the second signal, wherein the control information further includes an indication of one of the clockwise circular polarization type or the counterclockwise circular polarization type, and wherein to receive the signal, the at least one processor is configured to receive the signal in accordance with the one of the clockwise circular polarization type or the counterclockwise circular polarization type.

17. The first network node of claim 1, wherein the at least one processor is configured to:
determine a first circular polarization type of the signal received from the second network node, wherein the particular polarization type comprises a second circular polarization type determined based on the first circular polarization type.

18. A first network node for wireless communication, comprising:
a memory; and
at least one processor coupled to the memory, wherein the at least one processor is configured to:
receive, from a second network node, control information including an indication of a capability of the second network node to support forwarding in accordance with a first set of one or more polarization types; and
transmit, to the second network node and based on the control information, scheduling information for a communication resource, wherein the scheduling information includes an indication to apply a particular polarization type of the first set of one or more polarization types to the communication resource.

19. The first network node of claim 18, wherein the at least one processor is configured to:
transmit a signal to the second network node via the communication resource for forwarding to a third network node.

20. The first network node of claim 19, wherein the at least one processor is configured to:
transmit the signal in accordance with a first circular polarization type, and wherein the particular polarization type comprises a second circular polarization type different from the first circular polarization type.

21. The first network node of claim 20, wherein the control information further includes an indication of a second capability of the second network node to support simultaneous reception and forwarding of signals in accordance with different polarization types.

22. The first network node of claim 18, wherein the at least one processor is configured to:
transmit a second signal to the second network node, wherein the control information further includes an indication of a selected one of a clockwise circular polarization type or a counterclockwise circular polarization type, and wherein to transmit the signal, the at least one processor is configured to transmit the signal in accordance with the selected one of the clockwise circular polarization type or the counterclockwise circular polarization type.

23. The first network node of claim 18, wherein the at least one processor is configured to:
receive a signal from the second network node via the communication resource in accordance with the particular polarization type.

24. The first network node of claim 18, wherein the one or more polarization types include at least one of a clockwise circular polarization and a counterclockwise circular polarization.

25. The first network node of claim 24, wherein the control information further includes an indication of a respective power configuration associated with each respective polarization type of the one or more polarization types.

26. The first network node of claim 18, wherein the control information further includes an indication of a second capability of the second network node to support reception in accordance with a second set of one or more polarization types.

27. The first network node of claim 18, wherein the control information further includes an indication of a second capability of the second network node to support transmission in accordance with a second set of one or more polarization types.

28. The first network node of claim 18, wherein the control information further includes an indication of a second capability of the second network node to switch between forwarding in accordance with a first polarization type of the first set of one or more polarization types and forwarding in accordance with a second polarization type.

29. A method for wireless communications at a first network node, comprising:
transmitting control information including an indication of a capability of the first network node to support forwarding in accordance with a first set of one or more polarization types;
receiving, based on the control information, scheduling information for a communication resource, wherein the scheduling information includes an indication to apply a particular polarization type of the first set of one or more polarization types to the communication resource; and
forwarding a signal received from a second network node via the communication resource to a third network node in accordance with the scheduling information.

30. A method for wireless communications at a first network node, comprising:
receiving, from a second network node, control information including an indication of a capability of the second network node to support forwarding in accordance with a first set of one or more polarization types; and
transmitting, to the second network node and based on the control information, scheduling information for a communication resource, wherein the scheduling information includes an indication to apply a particular polarization type of the first set of one or more polarization types to the communication resource.
